(19) United States
(12) Patent Application Publication
(10) Pub. No.: US 2026/0001348 A1
(43) Pub. Date: Jan. 1, 2026

(54) LIQUID DROPLET EJECTING APPARATUS, LIQUID DROPLET EJECTING METHOD, AND MEDIUM STORING PROGRAM FOR LIQUID DROPLET EJECTING APPARATUS

(71) Applicant: BROTHER KOGYO KABUSHIKI KAISHA, Nagoya (JP)

(72) Inventor: Tomoya KONDO, Nagoya (JP)

(73) Assignee: BROTHER KOGYO KABUSHIKI KAISHA, Nagoya (JP)

(21) Appl. No.: 19/250,289

(22) Filed: Jun. 26, 2025

(30) Foreign Application Priority Data
Jun. 27, 2024 (JP) 2024-104032

(51) Int. Cl. B41J 2/21; B41J 2/165; G06K 15/02; G06K 15/10

(52) U.S. Cl. CPC B41J 2/2135; B41J 2/1652; B41J 2/2114; G06K 15/105; G06K 15/1868; G06K 15/188

(57) ABSTRACT

A liquid droplet ejecting apparatus includes: a first head configured to eject first liquid droplets from a plurality of first nozzles based on image data; a second head configured to eject second liquid droplets of a same color as a color of the first liquid droplets from a plurality of second nozzles based on the image data; a conveyor configured to convey a printing medium in a conveyance direction; a first moving device configured to move the first head and the second head in a movement direction crossing the conveyance direction; and a controller. The first head and the second head are disposed such that positions of first nozzles as a part of the plurality of first nozzles and positions of second nozzles as a part of the plurality of second nozzles overlap with one another in the conveyance direction in a predetermined joint area.

### REFERENCE TO RELATED APPLICATIONS

The present application claims the priority from Japanese Patent Application No. 2024-104032 filed on Jun. 27, 2024. The entire contents of the priority-claimed application are incorporated herein by reference.

### BACKGROUND ART

A known printing apparatus includes first nozzles which print an image on a printing medium based on image data with predetermined basic color ink and second nozzles which print the image on the printing medium based on the image data with special color ink different from the basic color inks. The basic color ink is exemplified by cyan ink, yellow ink, magenta ink, and black ink. On the other hand, the special color ink includes ink having a color different from the color of the basic color ink and exemplified by red ink, green ink, and blue ink.

### SUMMARY

The ejection failure due to drying is more likely to occur in a case where the ejection frequency of the nozzle is low. For example, in a configuration in which a plurality of heads are aligned in a conveyance direction of the printing medium, the singling printing is carried out in order to reduce the appearance of any stripe at a joint between passes. In the singling printing, an ejection amount of liquid droplet per one pass of the nozzle of each head is lowered. Therefore, the nozzle is easily dried. As a result, a problem arises such that the ejection failure is likely to occur.

In view of the above-described situation, an object of the present disclosure is to provide a liquid droplet ejecting apparatus, a liquid droplet ejecting method, and a medium storing a program for the liquid droplet ejecting apparatus each of which is capable of realizing such a situation that the ejection failure of the nozzles is less likely to occur.

A liquid droplet ejecting apparatus according to the present disclosure includes: a first head having a plurality of first nozzles, first liquid droplets being ejected from the plurality of first nozzles based on image data; a second head having a plurality of second nozzles, second liquid droplets having the same color as that of the first liquid droplets being ejected from the plurality of second nozzles, based on the image data; a conveyor, a printing medium being conveyed by the conveyor in a conveyance direction with respect to the first head and the second head; a first moving device, the first head and the second head being moved by the first moving device in a movement direction crossing the conveyance direction; and a controller. The first head and the second head are disposed such that positions of first nozzles as a part of the plurality of first nozzles and positions of second nozzles as a part of the plurality of second nozzles overlap with one another in the conveyance direction in a predetermined joint area. The controller is configured to execute a process of obtaining a dark area from ejection data as data after execution of a half tone process with respect to the image data, the dark area being an area with a total value of volume being a threshold value or more, the total value of volume being a total value of a cumulative volume of the first liquid droplets ejected from a row of the first nozzles aligned in the movement direction and a cumulative volume of the second liquid droplets ejected from a row of the second nozzles aligned in the movement direction; a process of determining whether a part or all of the joint area corresponds to the dark area in a following printing pass to be executed after a preceding printing pass as a predetermined printing pass; and a process of changing a number of the first nozzles to be used relevant to ejection and a number of the second nozzles to be used relevant to the ejection in the preceding printing pass, in the following printing pass, or in both of the preceding printing pass and the following printing pass such that the part or all of the joint area corresponds to the dark area in the following printing pass, in a case where the part or all of the joint area does not correspond to the dark area.

According to the present disclosure, in a case where the part of all of the joint area does not correspond to the dark area, the number of the first nozzles to be used relevant to the ejection and the number of the second nozzles to be used relevant to the ejection are changed in the preceding printing pass, in the following printing pass, or in both of the preceding printing pass and the following printing pass. Accordingly, the part or all of the joint area can be caused to correspond to the dark area, for example, in the following printing pass. That is, the liquid droplets, in which the total value of volume is the threshold value or more, can be ejected from the first nozzles and the second nozzles, for example, in the following printing pass. Accordingly, any ejection failure is less likely to occur in relation to the first nozzles and the second nozzles.

The liquid droplet ejecting apparatus, the liquid droplet ejecting method, and the medium storing the program for the liquid droplet ejecting apparatus according to the present disclosure each contribute to the realization of such a situation that the ejection failure of the nozzles is less likely to occur.

### BRIEF DESCRIPTION OF DRAWINGS

FIG. 1 is a plan view illustrating the configuration of a printing apparatus including a liquid droplet ejecting apparatus according to an embodiment.

FIG. 2 is a view illustrating nozzles disposed in a joint area in each of heads depicted in FIG. 1.

FIG. 3 is a block diagram illustrating the configuration of a control system of the printing apparatus depicted in FIG. 1.

FIG. 4 is a view illustrating a dark area and a light area each corresponding to a corresponding one of printing passes of ejection data, and FIG. 4 is also a view illustrating a histogram indicating a total value of volume of ink droplets corresponding to each of the dark area and the light area.

FIG. 5 is a view illustrating examples of the dark area and the light area corresponding to each of the printing passes of the ejection data.

FIG. 6 is a view illustrating examples of the dark area and the light area corresponding to each of the printing passes of the ejection data.

FIG. 7 is a view illustrating examples of the dark area and the light area corresponding to each of the printing passes of the ejection data.

FIG. 8 is a flow chart illustrating the flow of a process performed in the printing apparatus depicted in FIG. 1.

FIGS. 9A and 9B are a flow chart illustrating the flow of a pass dividing process depicted in FIG. 8.

FIG. 10 is a flow chart illustrating the flow of the pass dividing process continued from FIG. 9B.

FIGS. 11A and 11B are views illustrating a modification of a carriage depicted in FIG. 1.

FIG. 12 is a view illustrating examples of the dark area and the light area corresponding to each of printing passes of image data.

FIG. 13 is a view illustrating a printing pass in which a joint area is caused to correspond to dark areas.

FIG. 14 is a flow chart illustrating the flow of a process performed in a printing apparatus.

FIGS. 15A and 15B are a flow chart illustrating a flow of a block dividing and pass dividing process depicted in FIG. 14.

FIG. 16 is a flow chart illustrating the flow of the block dividing and pass dividing process continued from FIG. 15B.

### DESCRIPTION

A liquid droplet ejecting apparatus according to an embodiment of the present disclosure will be described below with reference to the drawings. The liquid droplet ejecting apparatus described below is merely an embodiment of the present disclosure. Therefore, the present disclosure is not limited to the following embodiment, and addition, deletion, and change can be made within a range without deviating from the gist or characteristics of the present disclosure. Note that in the following description, the same or corresponding elements are designated by the same reference numerals throughout all of the drawings, and any duplicated description will be omitted unless otherwise noted.

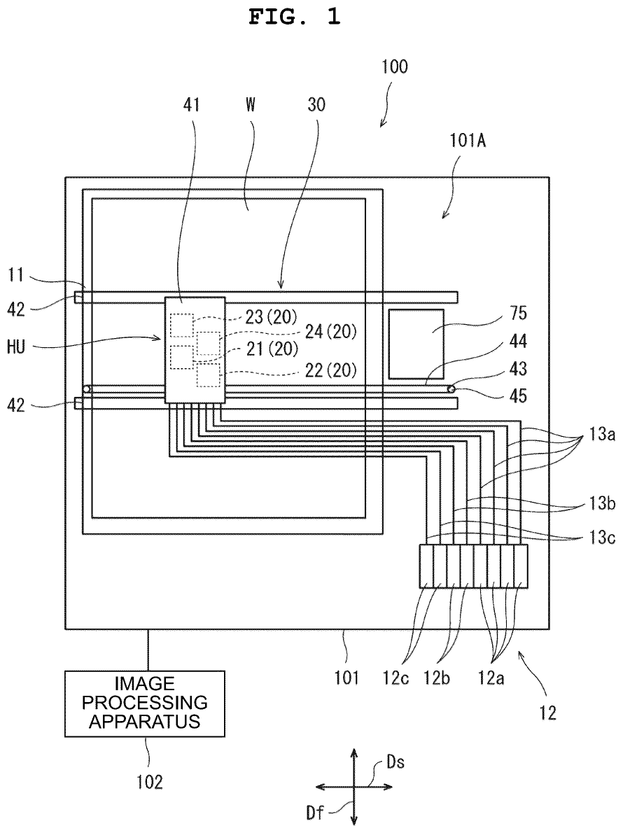

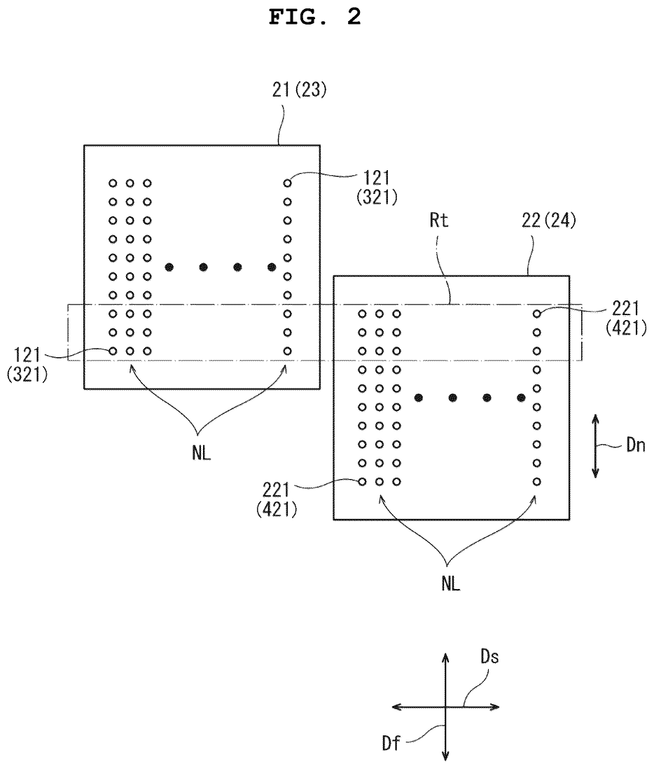

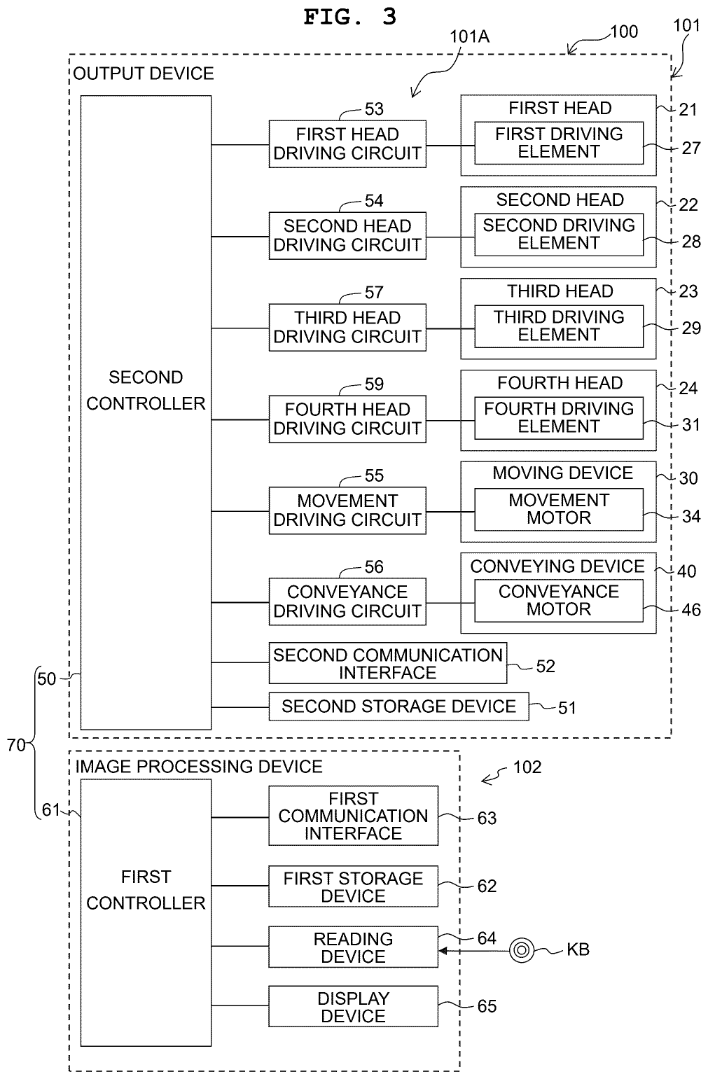

FIG. 1 is a plan view illustrating the configuration of a printing apparatus 100 including a liquid droplet ejecting device 101A according to an embodiment. FIG. 2 is a view illustrating nozzles disposed in a joint area Rt in each of a plurality of ink-jet heads 20 depicted in FIG. 1. FIG. 3 is a block diagram illustrating the configuration of a control system of the printing apparatus 100 depicted in FIG. 1. With reference to FIG. 1 and FIG. 2, the mutually orthogonal directions are designated as “first direction Df” and “second direction Ds”. In the present embodiment, for example, the first direction Df is a conveyance direction of a printing medium W, and the second direction Ds is a movement direction of a carriage 41 described later. In the following description, the second direction Ds is referred to as “movement direction Ds”, and the first direction Df is referred to as “conveyance direction Df”. However, the foregoing directions are referred as examples, and the present disclosure is not limited to these directions.

The printing apparatus 100 includes an output device 101 and an image processing apparatus 102. The output device 101 and the image processing device 102 are connected to each that to be capable of mutually communicating with each other wirelessly or via a wired communication such as, for example, a network. The image processing device 102 generates printing data from image data of a print image as an image to be printed on the printing medium W by the output device 101, and the image processing device 102 transmits the generated printing data to the output apparatus by means of the wireless line or the wired line. The output device 101 prints the print image on the printing medium W based on the printing data received from the image processing device 102. Note that examples of the printing medium W include, for example, sheets, cloth or fabric, resin materials, metal materials, and sheet films.

The output device 101 is, for example, an ink-jet printer based on the serial head system. The output device 101 alternately repeats, based on the printing data, a pass process of ejecting ink droplets while moving the plurality of ink-jet heads 20 (hereinafter referred to as the “(plurality of) heads 20”) in the movement direction Ds, and a conveying process of conveying the printing medium W in the conveyance direction Df. Accordingly, a predetermined image is printed on the printing medium W. Note that in FIG. 1, the printing medium W is conveyed in a direction included in the conveyance direction Df and moving upward from the bottom end to the top end on the sheet surface of FIG. 1.

The output device 101 has the liquid droplet ejecting device 101A. The liquid droplet ejecting device 101A includes a head unit HU, a platen 11, a plurality of tanks 12, a moving device 30, a conveyor 40, and a receiving part 75. Note that the moving device 30 corresponds to a first moving device.

The head unit HU has the plurality of heads 20. The plurality of heads 20 prints the image on the printing medium W with predetermined ink droplets based on the printing data. The plurality of heads 20, which are included in the head unit HU, are exemplified by a first ink-jet head 21 (hereinafter referred to as “first head 21”), a second ink-jet head 22 (hereinafter referred to as “second head 22”), a third ink-jet head 23 (hereinafter referred to as “third head 23”), and a fourth ink-jet head 24 (hereinafter referred to as “fourth head 24”). Note that in the following description, in a case where the plurality of heads are described as “the head 20”, the head 20 is the general term including the first head 21, the second head 22, the third head 23, and the fourth head 24.

For example, the first head 21 has a plurality of first nozzles 121 configured to eject, to the printing medium W, ink droplets of a color ink as first liquid droplets based on the image data. A second controller 50 described later causes the first head 21 to eject the ejection of the ink droplets of the color ink as the first liquid droplets from the first nozzles 121 of the first head 21. Further, the second head 22 has a plurality of second nozzles 221 configured to eject, to the printing medium W, ink droplets of the color ink as second liquid droplets having the same color as the color of the first liquid droplets based on the image data. The second controller 50 described later causes the second head 22 to eject the ink droplets of the color ink as the second liquid droplets from the second nozzles 221 of the second head 22. Note that the color ink is exemplified by inks of basic colors which are, for example, cyan ink, magenta ink, yellow ink, and black ink.

The third head 23 has a plurality of third nozzles 321 configured to eject, to the printing medium W, ink droplets of a special color ink as third liquid droplets based on the image data. The second controller 50 described later causes the third head 23 to eject the ink droplets of the special color ink as the third liquid droplets from the third nozzles 321 of the third head 23. Further, the fourth head 24 has a plurality of fourth nozzles 421 configured to eject, to the printing medium W, ink droplets of the special color ink as fourth liquid droplets having the same color as the color of the third liquid droplets based on the image data. The second controller 50 described later causes the fourth head 24 to eject the ejection of the ink droplets of the special color ink as the fourth liquid droplet from the fourth nozzles 421 of the fourth head 24. Note that the special color ink is the ink having a color different from the color of the basic color ink, which is exemplified, for example, by red ink, green ink, and blue ink. However, the foregoing color of the ink ejected from each of the heads 20 is referred to merely as an example, and the color can be appropriately changed.

The second head 22, the first head 21, the fourth head 24, and the third head 23 are disposed in this order as starting from the upstream side in the conveyance direction Df. For example, the first head 21, the second head 22, the third head 23, and the fourth head 24 are disposed in a zigzag form.

The configuration of the first head 21 and the configuration of the third head 23 are, for example, identical with each other, and the configuration of the second head 22 and the configuration of the fourth head 24 are, for example, identical with each other. As depicted in FIG. 2, the first head 21 and the second head 22 are disposed so that positions of first nozzles 121 as a part of the plurality of first nozzles 121 and positions of second nozzles 221 as a part of the plurality of second nozzles 221 overlap with one another in the conveyance direction Df in a predetermined joint area Rt. In other words, in the predetermined joint area Rt, the positions of the first nozzles 121 as the part of the plurality of first nozzles 121 are the same as the positions of the second nozzles 221 as the part of the plurality of second nozzles 221 in the conveyance direction Df. Further, the third head 23 and the fourth head 24 are disposed so that positions of nozzles 321 as a part of the plurality of third nozzles 321 and positions of nozzles 421 as a part of the plurality of fourth nozzles 421 overlap with one another in the conveyance direction Df in a predetermined joint area Rt. In other words, in the predetermined joint area Rt, the positions of the third nozzles 321 as the part of the plurality of third nozzles 321 are the same as the positions of the fourth nozzles 421 as the part of the plurality of fourth nozzles 421 in the conveyance direction Df. Note that the number of nozzles included in the joint area Rt in relation to a certain nozzle array NL can be appropriately set.

The first head 21 has a plurality of nozzle arrays NL. Each of the nozzle arrays NL is constructed of first nozzles 121, included in the plurality of first nozzles 121 and aligned at predetermined intervals in a predetermined nozzle array direction Dn. Each of the nozzle arrays NL extends in the nozzle array direction Dn. The nozzle array direction Dn is a direction which is, for example, parallel to the conveyance direction Df. The plurality of nozzle arrays NL are disposed at predetermined intervals in the movement direction Ds. The disposition of the nozzle arrays NL constructed of the plurality of second nozzles 221 of the second head 22, the disposition of the nozzle arrays NL constructed of the plurality of third nozzles 321 of the third head 23, and the disposition of the nozzle arrays NL constructed of the plurality of fourth nozzles 421 of the fourth head 24 are the same as the disposition of the foregoing nozzle arrays NL of, for example, the first head 21.

In the present embodiment, each of the plurality of first nozzles 121, the plurality of second nozzles 221, the plurality of third nozzles 321, and the plurality of fourth nozzles 421 are capable of ejecting, as the ink droplets, any one of a large droplet, a middle droplet, and a small droplet.

The platen 11 has a flat upper surface. The platen 11 defines the distance between the printing medium W which is to be placed on the upper surface of the platen 11 and a nozzle surface of each of the heads 20 which is disposed to face the upper surface of the platen 11. The platen 11 moves in the conveyance direction Df. Accordingly, the printing medium W, which is supported by the platen 11, is moved in the conveyance direction Df.

Each of the inks are stored in a corresponding one of the plurality of tanks 12. Each of the plurality of tanks 12 is connected to a corresponding one of the plurality of heads 20 via a flow passage described later, in order to supply the ink to the corresponding one of the plurality of heads 20. Each of the plurality of tanks 12 is a container configured to store the ink. The number of the tank 12 is the same as or more than the number of type of the ink. For example, the plurality of tanks 12 include: four first tanks 12a configured to store four types of color inks, respectively; one second tank 12b or a plurality of second tanks 12b configured to store one special color ink or a plurality of special color inks; and one third tank 12c or a plurality of third tanks 12c configured to store one special color ink or a plurality of special color inks having the same color(s) as the color(s) of the special color(s) as described above. However, the number of the tank 12 and the number of the type of the ink stored by the above-described tanks 12 are referred merely as examples, and the present disclosure is not limited to the number of the tank 12 and the number of the type of the ink as described above.

The first tanks 12a are communicated with the first head 21 and the second head 22 with first flow passages 13a. The color inks are supplied to the first head 21 and the second head 22 via the first flow passages 13a from the first tanks 12. The second tanks 12b are communicated with the third head 23 with second flow passages 13b. The special color inks are supplied to the third head 23 via the second flow passages 13b from the second tanks 12b. The third tanks 12c are communicated with the fourth head 24 with third flow passages 13c. The special color inks are supplied to the fourth head 24 via the third flow passages 13c from the third tanks 12c.

The conveyor 40 has a conveyance motor 46 and a driving part including, for example, an unillustrated ball screw or a rack and pinion. The driving part is connected to the conveyance motor 46. The conveyor 40 conveys the printing medium W in the conveyance direction Df with respect to the first head 21, the second head 22, the third head 23, and the fourth head 24. In particular, the platen 11 is moved in the conveyance direction Df in accordance with the rotary action of the conveyance motor 46. Accordingly, the printing medium W is conveyed in the conveyance direction Df.

The moving device 30 has the carriage 41, two guide rails 42, a movement motor 34, and an endless belt 44. The two guide rails 42 extend in the movement direction Ds at a location above the platen 11 so that the carriage 41 is interposed between the two guide rails 42 in the conveyance direction Df. The carriage 41 supports the first head 21, the second head 22, the third head 23, and the fourth head 24. The carriage 41 is supported by the two guide rails 42 so that the carriage 41 is movable in the movement direction Ds. The endless belt 44 extends in the movement direction Ds and is attached to the carriage 41. Further, the endless belt 44 is attached to the movement motor 34 via a pulley 45. The endless belt 44 operates as the movement motor 34 rotates, thereby causing the carriage 41 to reciprocatively move in the movement direction Ds along the guide rails 42 so as to move the first head 21, the second head 22, the third head 23, and the fourth head 24 in the movement direction Ds. Accordingly, the first head 21, the second head 22, the third head 23, and the fourth head 24 are reciprocatively moved in the movement direction Ds.

The receiving part 75 is disposed adjacent to one end parts, in the movement direction Ds of the carriage 41, of the guide rails 42 so that the receiving part 75 overlaps with a movement area, of the carriage 41, which extends in the movement direction Ds. The receiving part 75 receives the ink droplets discharged from the heads 20 by a flushing process. The flushing process is performed while each of the heads 20 is located at a position above the receiving part 75 by the carriage 41. Specifically, the receiving part 75 receives the ink droplets of the color inks discharged from the plurality of nozzles 121 of the first head 21 and the plurality of nozzles 221 of the second head 22 and the ink droplets of the special color inks discharged from the plurality of nozzles 321 of the third head 23 and the plurality of nozzles 421 of the fourth head 24. The second controller 50 described later causes each of the heads to execute the flushing process before the start of the printing performed by the first head 21, the second head 22, the third head 23, and the fourth head 24. Note that the respective ink droplets, which are received by the receiving part 75, are exhausted via an unillustrated piping connected to the receiving part 75.

Next, as depicted in FIG. 3, the first head 21 includes first driving elements 27 each of which is disposed with respect to a corresponding one of the nozzles 121. The second head 22 includes second driving elements 28 each of which is disposed with respect to corresponding one of the nozzles 221. The third head 23 includes third driving elements 29 each of which is disposed with respect to a corresponding one of the nozzles 321. The fourth head 24 includes fourth driving elements 31 each of which is disposed with respect to a corresponding one of the nozzles 421. The first driving elements 27, the second driving elements 28, the third driving elements 29, and the fourth driving elements 31 are, for example, piezoelectric elements, heat generating elements, or electrostatic actuators. Each of the first driving elements 27, the second driving elements 28, the third driving element 29 and the fourth driving elements 31 apply the pressure to the inks so as to eject the ink droplets from the corresponding one of the nozzles 121, the nozzles 221, the nozzles 321, and the nozzles 421.

The output device 101 includes the second controller 50. Further, the output device 101 includes a second storage device 51, a second communication interface 52, a first head driving circuit 53, a second head driving circuit 54, a third head driving circuit 57, a fourth head driving circuit 59, a movement driving circuit 55, and a conveyance driving circuit 56 which are connected to the second controller 50.

A second storage device 51 is a memory which is accessible from the second controller 50, and the second storage device 51 has, for example, RAM and ROM. The RAM temporarily stores printing data and various kinds of data (to be used) during calculation performed by the second controller 50. The ROM stores a liquid droplet ejecting program and various kinds of data (to be used) to perform various kinds of data processing.

The second controller 50 is constructed of a computer, and the second controller 50 includes, for example, a processor such as a CPU. The second controller 50 executes the liquid droplet ejecting program while referring to the data stored in the second storage device 51 so as to control the operation of the respective parts of the output device 101. The second controller 50 receives ejection data from a first controller 61 via the second communication interface 52. The second controller 50 executes a pass dividing process based on the received ejection data. The pass dividing process will be described in detail later. Note that the second controller 50 may be constructed of a single device, or the second controller 50 may be configured so that a plurality of devices, which are disposed independently, cooperate to control the operation of the output device 101. Further, the second controller 50 receives various kinds of data including, for example, the printing data from the image processing device 102 via the second communication interface 52.

The first head driving circuit 53 controls the operation of the first driving element 27 based on an instruction from the second controller 50. In this case, the second controller 50 outputs, to the first head driving circuit 53, a control signal with which the first driving element 27 is to be driven. The first head driving circuit 53 generates a driving signal based on the control signal. The driving signal is outputted to the first driving element 27. The first driving element 27 applies predetermined ejection energy to the color ink supplied to the inside of the first head 21 at a predetermined timing based on the driving signal. Accordingly, the ink droplets of the color ink are ejected from the nozzles 121. Similarly, the second head driving circuit 54 controls the operation of the second driving element 28 based on an instruction from the second controller 50. Accordingly, the ink droplets of the color ink are ejected from the nozzles 221. The third head driving circuit 57 controls the operation of the third driving element 29 based on an instruction from the second controller 50. Accordingly, the ink droplets of the special color ink are ejected from the nozzles 321. The fourth head driving circuit 59 controls the operation of the fourth driving element 31 based on an instruction from the second controller 50. Accordingly, the ink droplets of the special color ink are ejected from the nozzles 421.

The movement driving circuit 55 controls the operation of the movement motor 34 included in the moving device 30 based on an instruction from the second controller 50. As the movement motor 34 is operated, the carriage 31 reciprocatively moves in the movement direction Ds. Therefore, the first head 21, the second head 22, the third head 23, and the fourth head 24 are moved in the movement direction Ds.

The conveyance driving circuit 56 controls the operation of the conveyance motor 46 included in the conveyor 40 based on an instruction from the second controller 50. As the conveyance motor 46 is operated, the platen 11 conveys the printing medium W in the conveyance direction Df intermittently or continuously. Further, the platen 11 stops the printing medium W at a predetermined position in the conveyance direction Df.

The image processing device 102 is an apparatus configured to process a print image to be printed by the output device 101. The image processing device 102 is constructed, for example, of a personal computer, a tablet, or a smartphone. The image processing device 102 includes a first controller 61 and a first storage device 62, a first communication interface 63, a reading device 64, and a display device 65 which are connected to the first controller 61.

The first storage device 62 is a memory which is accessible from the first controller 61. The first storage device 62 has, for example, RAM and ROM. The RAM temporarily stores image data and various kinds of data (to be used) during a calculation performed by the first controller 61. The ROM stores a processing program and various kinds of data (to be used) to perform various kinds of data processing. The image data is exemplified, for example, by raster data indicating an image to be printed on the printing medium W.

The first controller 61 is constructed of a computer. The first controller 61 includes, for example, a processor such as CPU. The first controller 61 executes the processing program while referring to the data stored in the first controller 61 so as to control the operation of the output device 101 and the operation of the display device 65. The first controller 61 obtains the image data. The image data is exemplified, for example, by data in which each of the RGB values has a value of 256 gradations. The first controller 61 executes a color conversion process with respect to the image data. Accordingly, the first controller 61 obtains the image data represented by CMYK values as color coordinates in the CMYK space depending on the device. Further, the first controller 61 applies a half tone process to the image data after the color conversion process has been executed with respect to the image data. Accordingly, the first controller 61 obtains the ejection data (dot data). The first controller 61 transmits the ejection data to the second controller 50 via the first communication interface 63. Note that the first controller 61 may be constructed of a single device, or the first controller 61 may be configured so that a plurality of devices, which are disposed independently, cooperate to control the operation of the image processing device 102. The first controller 61 transmits various kinds of data such as, for example, the printing data, to the output device 101 via the first communication interface 63. In the present embodiment, the first controller 61 cooperates with the second controller 50 of the output device 101 to construct a controller 70 of the printing apparatus 100.

The reading device 64 reads out, for example, the liquid droplet ejecting program stored in a storage medium KB including, for example, CD-ROM and USB flash memory. The read liquid droplet ejecting program, for example, is stored in the first storage device 62. Alternatively, the liquid droplet ejecting program may be downloaded via a predetermined communication network, and the liquid droplet ejecting program may be stored in the first storage device 62. The display device 65 is, for example, a touch panel display. Information regarding an operation by a user is outputted to the first controller 61. Further, the display device 65 displays, for example, a print image to be printed by the output device 101 based on the image data.

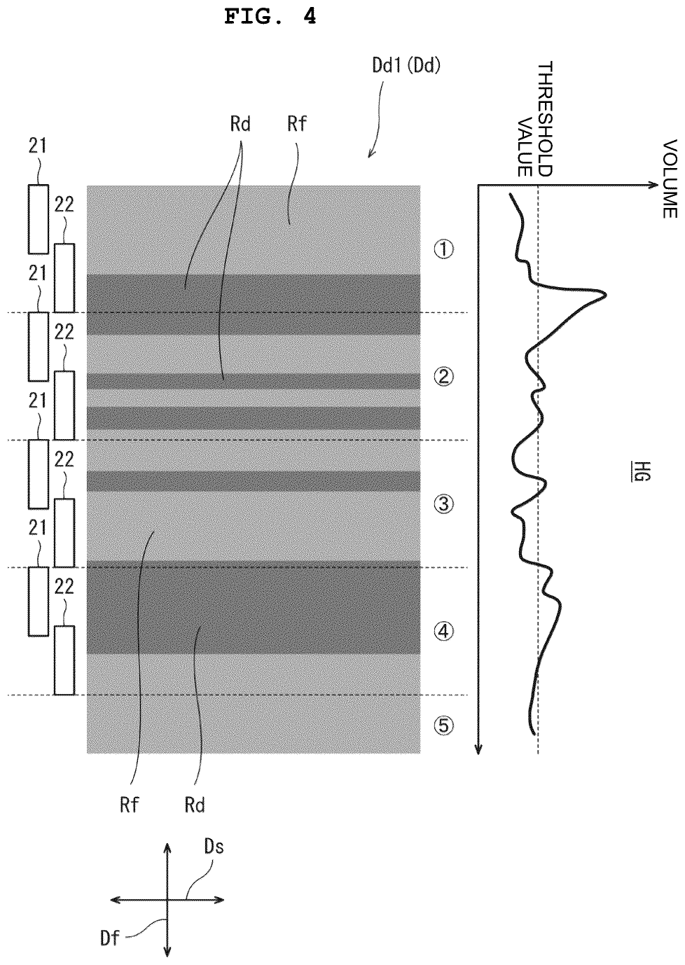

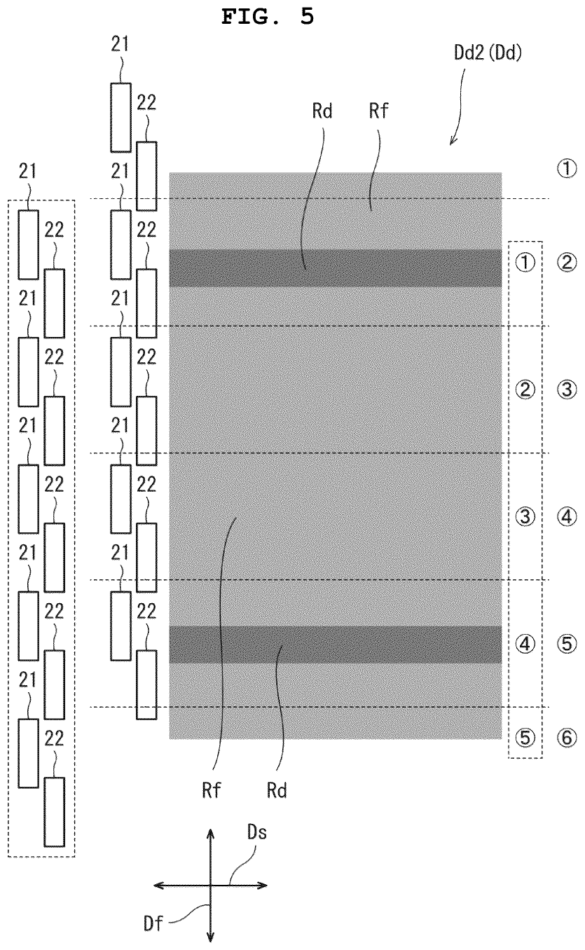

Next, the process performed by the second controller 50 in the first embodiment will be described in detail with reference to the drawings. FIG. 4 is a view illustrating a dark area Rd and a light area Rf each of which corresponds to a corresponding one of printing passes of ejection data Dd, and FIG. 4 is a view illustrating a histogram HG indicating a volume total value of ink droplets corresponding to each of the dark area Rd and the light area Rf. FIG. 5 to FIG. 7 each illustrate examples of the dark area Rd and the light area Rf corresponding to a corresponding one of printing passes of the ejection data Dd.

The second controller 50 executes the following processes as the pass dividing process. At first, the second controller 50 obtains, from the first controller 50, the ejection data Dd as data wherein the half tone process has been executed with respect to the image data. The second controller 50 obtains, from the obtained ejection data Dd, a total value of volume as a total value of a cumulative volume of the ink droplets of the color ink ejected from first nozzles 121 aligned in the movement direction Ds, and a cumulative volume of the ink droplets of the color ink ejected from second nozzles 221 aligned in the movement direction Ds. In this case, the second controller 50 obtains the total value of the cumulative volume of the ink droplets (ink droplets each composed of any one of the large droplet, middle droplet, and small droplet) to be ejected from the first nozzles 121 aligned in the movement direction Ds of the first nozzles 121 of the first head 21 and the cumulative volume of the ink droplets (ink droplets each composed of any one of the large droplet, middle droplet, and small droplet) to be ejected from the second nozzles 221 aligned in the movement direction Ds of the second nozzles 221 of the second head 22, with respect to every row of the nozzles aligned in the movement direction Ds (i.e., every row orthogonal to the nozzle column direction Dn as depicted in FIG. 2). Note that the second head 22 is disposed while being shifted, with respect to the first head 21, by a predetermined distance in the conveyance direction Df. On this account, the total value of volume, which is obtained with respect to every row of the nozzles aligned in the movement direction Ds, include the value which is composed of only the cumulative total value of the ink droplets ejected from the first nozzles 121, the value which is composed of both of the cumulative total value of the ink droplets ejected from the first nozzles 121 and the cumulative total value of the ink droplets ejected from the second nozzles 221, and the value which is composed of only the cumulative total value of the ink droplets ejected from the second nozzles 221.

Next, as depicted in FIG. 4, the second controller 50 generates the histogram HG of the obtained total value of volume. The histogram HG indicates the relationship between the position of the row (i.e., position, of the row, in the conveyance direction Df in the ejection data Dd) and the total value of volume corresponding to the position.

Then, the second controller 50 executes a process of obtaining the dark area Rd as an area in which the total value of volume is a threshold value or more. The dark area Rd is the area which expands in the conveyance direction Df and the movement direction Ds. In this case, the dimension of the dark area Rd in the conveyance direction Df may be the same or more than the distance ranging from the center of a nozzle disposed adjacent to one end in the conveyance direction Df of the joint area Rt of the first head 21 and the second head 22 and the center of another nozzle disposed adjacent to the other end in the conveyance direction Df of the joint area Rt of the first head 21 and the second head 22. Further, the dimension of the dark area Rd in the movement direction Ds may be the same or more than a dimension in the movement direction Ds which can be maximally reproduced by the ejection data Dd. The second controller 50 executes a process of obtaining the light area Rf as the area in which the total value of volume is less than the threshold value. In the case of ejection data Dd1 depicted in FIG. 4 as an example of the ejection data Dd, the area depicted in dark grey is the dark area Rd and the area depicted in light grey is the light area Rf. In FIG. 4, first to fifth printing passes, which are examples of the printing passes of the first head 21 and the second head 22, are determined by numerals of 1 to 5 affixed with blanked circles. Note that the distinction between the illustration of the dark area Rd and the illustration of the light area Rf in each of FIG. 5 to FIG. 7 and the distinction between the illustrations of the respective printing passes are the same as or equivalent to the illustrations depicted in FIG. 4.

The second controller 50 executes a process of determining whether a part or all of the joint area Rt corresponds to the dark area Rd in a following printing pass as a printing pass which is to be executed after a preceding printing pass as a predetermined printing pass. For example, the preceding printing pass is the first printing pass or a printing pass following the first printing pass, and the following printing pass is the second printing pass or a printing pass following the second printing pass. This case will be described with reference to an example depicted in FIG. 4 as follows. That is, the second controller 50 determines that a part or all of the joint area Rt corresponds to the dark area Rd in the second printing pass. Further, in a case where the following printing pass is the third printing pass, the second controller 50 determines that a part or all of the joint area Rt does not correspond to the dark area Rd in the third printing pass. Further, in a case where the following printing pass is the fourth printing pass, the second controller 50 determines that the part or all of the joint area Rt corresponds to the dark area Rd in the fourth printing pass.

In this way, in the example depicted in FIG. 4, the part or all of the joint area Rt corresponds to the dark area Rd in the following printing pass (the second printing pass with respect to the first printing pass, and the fourth printing pass with respect to the third printing pass) to be performed after the preceding printing pass (the first printing pass with respect to the second printing pass, and the third printing pass with respect to the fourth printing pass) in which the part or all of the joint area Rt does not correspond to the dark area Rd. In such a situation, the drying is less likely to occur, since the time interval, which ranges from no ejection to ejection, is relatively short in the first nozzles 121 and the second nozzles 221 in the joint area Rt. On account of the circumstances as described above, in a case where the ejection data Dd is the ejection data Dd1 as described above, the second controller 50 does not execute a process of changing the number of the first nozzles 121 to be used relevant to the ejection and the number of the second nozzles 221 to be used relevant to the ejection as will be described later.

Next, reference is made to ejection data Dd2 depicted in FIG. 5, in contrast to FIG. 4 described above. In FIG. 5, broken lines in rectangular shapes surround the first heads 21 and the second heads 22, and the printing passes of the first heads 21 and the second heads 22, in a state that before the process described later of changing the number of the first nozzles 121 to be used relevant to the ejection and the number of the second nozzles 221 to be used relevant to the ejection is executed, so that the following description is easily understood.

Regarding the broken lines in rectangular shapes depicted in FIG. 5, in the same manner as in FIG. 4, the preceding printing pass is the first printing pass or a printing pass following the first printing pass, and the following printing pass is the second printing pass or a printing pass following the second printing pass. The second controller 50 determines that a part or all of the joint area Rt corresponds to the dark area Rd in the first printing pass. Further, the second controller 50 determines that a part or all of the joint area Rt does not correspond to the dark area Rd in the second printing pass and in the third printing pass. Furthermore, the second controller 50 determines that a part or all of the joint area Rt corresponds to the dark area Rd in the fourth printing pass. In this way, in the example depicted in FIG. 5, the part or all of the joint area Rt corresponds to the dark area Rd in the first printing pass. In the first printing pass, the drying in the first nozzles 121 and the second nozzles 221 in the joint area Rt occurs rather less frequently, since the flushing process has been executed before the printing pass is executed.

In view of the above situation, the second controller 50 executes the following process. That is, in order to cause the part or all of the joint area Rt to correspond to the dark area Rd in the second printing pass as the following printing pass, the second controller 50 changes the number of the first nozzles 121 to be used relevant to the ejection and the number of the second nozzles 221 to be used relevant to the ejection in the preceding printing pass. In this case, the second controller 50 decreases the number of the first nozzles 121 to be used relevant to the ejection and the number of the second nozzles 221 to be used relevant to the ejection in the first printing pass as the preceding printing pass (i.e., the first printing pass not surrounded by the broken lines in the rectangular shape) so that the dark area Rd corresponds to the part or all of the joint area Rt in the second printing pass as the following printing pass (i.e., the second printing pass not surrounded by the broken lines in the rectangular shape). In other words, the area to be formed by the first nozzles 121 and the second nozzles 221 in the first printing pass is the light area Rf, or an area, which is to be formed by the first nozzles 121 and the second nozzles 221, is not present. In combination with the process of decreasing the number of the first nozzles 121 to be used relevant to the ejection and the number of the second nozzles 221 to be used relevant to the ejection, the second controller 50 changes the conveyance amount of the printing medium W by the conveyor 40 so that the dark area Rd corresponds to the part or all of the joint area Rt in the second printing pass as described above. Note that the second controller 50 may change the number of the first nozzles 121 to be used relevant to the ejection and the number of the second nozzles 221 to be used relevant to the ejection in the preceding printing pass, in the following printing pass, or in both of the preceding printing pass and the following printing pass.

In this procedure, after the second controller 50 obtains the dark area Rd in the ejection data Dd2 as described above, the second controller 50 executes a process of determining whether a number of the following printing passes with the part or all of the joint area Rt not corresponding to the dark area Rd is a predetermined number or more. In the example depicted in FIG. 5, the second controller 50 determines that a predetermined number or more of the following printing passes (in FIG. 5, for example, two following printing passes: the third printing pass and the fourth printing pass correspond to the above-described definition), in which the part or all of the joint area Rt does not correspond to the dark area R, continue. In this way, in a case where the number of the following printing passes with the part or all of the joint area Rt not corresponding to the dark area Rd is the predetermined number or more, after the second controller 50 executes the printing in the predetermined number of following printing passes, the second controller 50 causes, in the flushing process, the first head 21 to discharge the ink droplets of the color ink from the first nozzles 121 of the first head 21 with respect to the receiving part 75 and causes the second head 22 to discharge the ink droplets of the color ink from the second nozzles 221 of the second head 22 with respect to the receiving part 75.

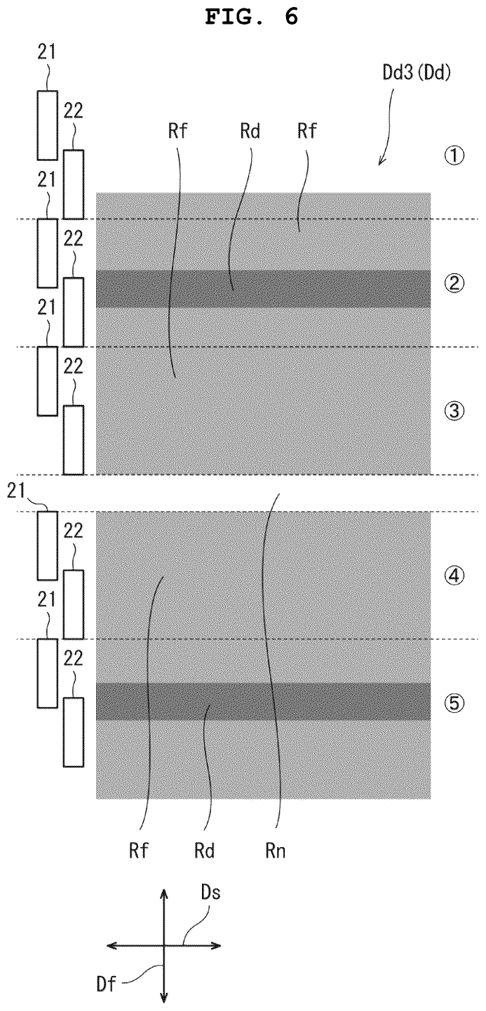

Next, with reference to ejection data Dd3 depicted in FIG. 6, the ejection data Dd3 is different from the ejection data Dd2 depicted in FIG. 5 in that a blank area Rn is present between the third printing pass and the fourth printing pass. In such a situation, the second controller 50 causes the conveyor 40 to convey the printing medium W in the conveyance direction Df corresponding to the blank area Rn described above. Further, the second controller 50 executes the flushing process between the third printing pass and the fourth printing pass.

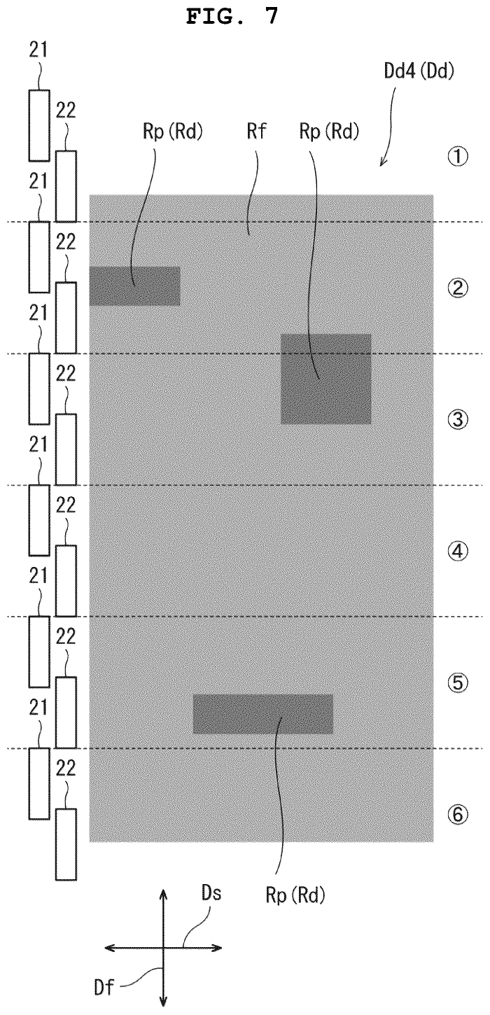

Next, with reference to ejection data Dd4 depicted in FIG. 7, the ejection data Dd4 is different from the ejection data Dd2 depicted in FIG. 5 in that the length of the dark area Rd in the movement direction Ds is less than a predetermined value, and the length is short. That is, the ejection data Dd4 includes a partial dark area Rp in which the dark area Rd is partially present in the movement direction Ds. In the example depicted in FIG. 7, a part or all of the joint area Rt corresponds to the partial dark area Rp in the second printing pass and in the third printing pass as the following printing passes. Further, a part or all of the joint area Rt does not correspond to the dark area Rd in the printing pass (fourth printing pass in FIG. 7) as a next printing pass with respect to the following printing passes in which the partial dark area Rp continues as described above.

With respect to the partial dark area Rp as described above, the ink droplets are less likely to be ejected in a sufficient amount to such an extent that the drying of the nozzles can be reduced. In a case where a predetermined number or more (for example, two) of the partial dark areas Rp continue in the following printing pass as described above, and where a part or all of the joint area Rt does not correspond to the dark area Rd in the next printing pass to the following printing pass, the second controller 50 executes the flushing process after the execution of the printing corresponding to the next printing pass. Note that even in a case where a plurality of partial dark areas Rp are present while being separated from each other in the movement direction Ds in one following printing pass, performing the flushing process in a similar manner as described above is preferred.

Although the pass dividing process relevant to the first head 21 and the second head 22 has been described above, the pass dividing process may be executed in the same manner as described above in relation to the third head 23 and the fourth head 24 as well. In this case, in the following printing pass, the second controller 50 may cause the third head 23 and the fourth head 24 to eject the special color ink droplets from the third nozzles 321 and the fourth nozzles 421 in the joint area Rt in preference to causing the first head 21 and the second head 22 to eject the color ink droplets from the first nozzles 121 and the second nozzles 221 in the joint area Rt. In this situation, the second controller 50 changes the number of the third nozzles 321 to be used relevant to the ejection and the number of the fourth nozzles 421 to be used relevant to the ejection in the preceding printing pass such that a part or all of the joint area Rt in the third head 23 and the fourth head 24 corresponds to the dark area Rd in the following printing pass. The term “in preference to” in the present embodiment may mean ejecting from the third nozzles 321 and the fourth nozzles 421 in the joint area Rt without ejecting from the first nozzles 121 and the second nozzles 221 in the joint area Rt.

Further, in the following printing pass, the second controller 50 may give priority to ejecting from nozzles with fewer ejections among the first nozzles 121 and the second nozzles 221 that are included in the joint area Rt. Similarly, in the following printing pass, the second controller 50 may give priority to ejecting from nozzles with fewer ejections among the third nozzles 321 and the fourth nozzles 421 that are included in the joint area Rt. The number of ejections may be based, for example, on the ejection data Dd. Alternatively, the number of ejections may be based on the driving signal generated by each of the head driving circuits. The term “give priority to” in the present embodiment may mean ejecting only from the nozzles with fewer ejections without ejecting from the other nozzles with more ejections among the first nozzles 121 and the second nozzles 221.

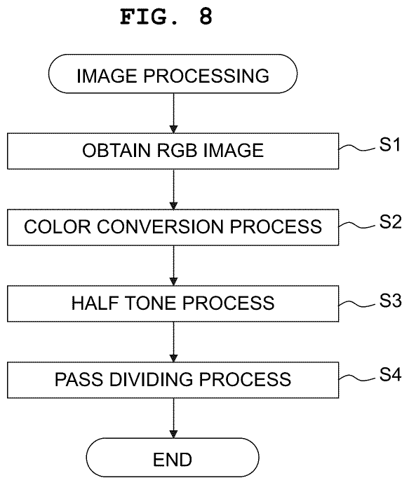

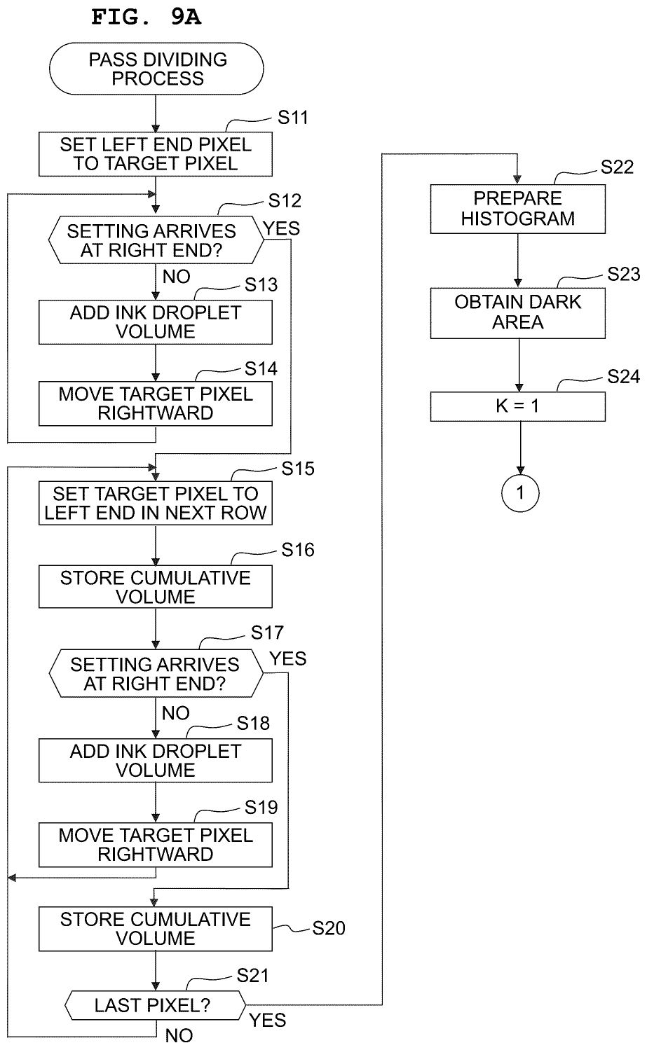

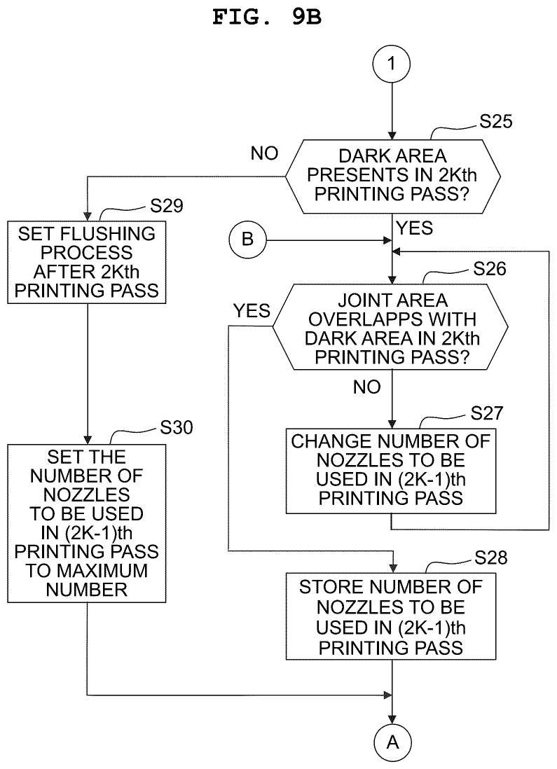

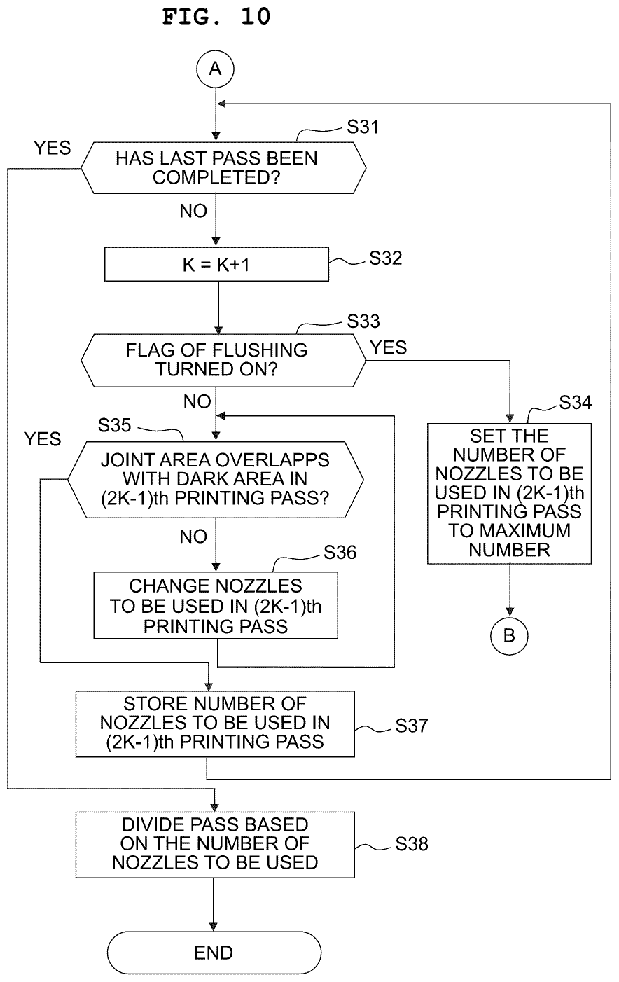

Next, an image processing including a pass dividing process performed in the printing apparatus 100 will be described with reference to flow charts depicted in FIGS. 8 to 10. FIG. 8 is a flow chart illustrating the flow of a process performed in the printing apparatus 100 depicted in FIG. 1. FIGS. 9A and 9B are a flow chart illustrating the flow of the pass dividing process depicted in FIG. 8. FIG. 10 is a flow chart illustrating the flow of the pass dividing process continued from FIG. 9B.

As depicted in FIG. 8, the first controller 61 of the image processing device 102 firstly obtains image data composed of RGB values (Step S1). Subsequently, the first controller 61 executes the color conversion process with respect to the image data, and thus the first controller 61 obtains the image data represented by CMYK values as color coordinates in the CMYK space depending on the device (Step S2). Then, the first controller 61 applies the half tone process to the image data after executing the color conversion process with respect to the image data, and thus the first controller 61 obtains the ejection data Dd (Step S3). The first controller 61 transmits the ejection data Dd to the second controller 50 of the output device 101 via the first communication interface 63. Subsequently, the second controller 50 receives the ejection data Dd from the first controller 61, and then the second controller 50 executes the following pass dividing process (Step S4).

At first, the second controller 50 obtains, from the obtained ejection data Dd, a total value of volume of a cumulative volume (hereinafter referred to as “one cumulative volume”) of the ink droplets of the color ink ejected from the first nozzles 121 aligned in the movement direction Ds and a cumulative volume (hereinafter referred to as “the other cumulative volume”) of the ink droplets of the color ink ejected from the second nozzles 221 aligned in the movement direction Ds in relation to each row of the nozzles aligned in the movement direction Ds. In this case, as indicated in FIG. 9A, the second controller 50 sets a left end pixel in the first row in the ejection data Dd (for example, the ejection data Dd2 depicted in FIG. 5) to a target pixel (Step S11). Subsequently, the second controller 50 determines whether the setting of the target pixel arrives at a right end pixel in the first row (Step S12).

In a case where the second controller 50 determines that the setting of the target pixel does not arrive at the right end pixel in the first row (No in Step S12), the second controller 50 adds the volume of the ink droplets corresponding to the pixel set as the target pixel as one cumulative volume and the other cumulative volume (Step S13). Then, the second controller 50 changes and sets the target pixel from the left end pixel to the pixel located adjacent to the right of the left end pixel (Step S14), and then the second controller 50 returns to the process of Step S12 described above to repeat this process and the following processes.

On the other hand, in a case where the second controller 50 determines that the setting of the target pixel arrives at the right end pixel in the first row (Yes in Step S12), i.e., in a case where the obtainment of the total value of volume as the total value of one cumulative volume and the other cumulative volume in relation to the first row is completed, the second controller 50 sets the left end pixel in the next row (for example, on the second row) in the ejection data Dd to the target pixel (Step S15). After that, the second controller 50 stores the total value of volume of one cumulative volume and the other cumulative volume in the first row in the second storage device 51, and the second controller 50 returns one cumulative volume and the other cumulative volume to initial values (for example, zero) (Step S16).

Subsequently, the second controller 50 determines whether the setting of the target pixel arrives at the right end pixel in the row (for example, the second row) relevant to the next row (step S17).

In a case where the second controller 50 determines that the setting of the target pixel does not arrive at the right end pixel (No in Step S17), the second controller 50 adds the volume of the ink droplets corresponding to the pixel set as the target pixel as one cumulative volume and the other cumulative volume (Step S18). Then, the second controller 50 changes and sets the target pixel from the left end pixel to the pixel located adjacent to the right of the left end pixel (Step S19), and then the second controller 50 returns to the process of Step S15 described above to repeat this process and the following processes. On the other hand, in a case where the second controller 50 determines that the setting of the target pixel arrives at the right end pixel in the row (for example, the second row) relevant to the next row (Yes in Step S17), the second controller 50 stores the total value of volume of one cumulative volume and the other cumulative volume in the row (for example, the second row) relevant to the next row in the second storage device 51 (Step S20).

After that, the second controller 50 determines whether the setting of the target pixel arrives at the last pixel (Step S21). In a case where the second controller 50 determines that the setting of the target pixel does not arrive at the last pixel (No in Step S21), the second controller 50 returns to the process of Step S15 described above to repeat this process and the following processes. On the other hand, in a case where the second controller 50 determines that the setting of the target pixel arrives at the last pixel (Yes in Step S21), the second controller 50 generates the histogram HG corresponding to the ejection data Dd as described with reference to FIG. 4 (Step S22).

Next, the second controller 50 obtains the dark area Rd based on the generated histogram HG (Step S23). Then, the second controller 50 sets a variable K, based on the ordinal number of the printing pass in relation to the first head 21 and the second head, to be 1 (K=1) (Step S24).

The second controller 50 determines whether the dark area Rd is present in a 2Kth printing pass as the following printing pass (for example, the second printing pass in the case of K=1) (Step S25). In a case where the second controller 50 determines that the dark area Rd is present in the 2Kth printing pass (Yes in Step S25), the second controller 50 determines whether a part or all of the joint area Rt overlaps with the dark area Rd in the 2Kth printing pass (Step S26).

In a case where the second controller 50 determines that the part or all of the joint area Rt overlaps with the dark area Rd in the 2Kth printing pass (Yes in Step S26), the second controller 50 stores the numbers of nozzles of the first nozzles 121 and the second nozzles 221 to be used in the (2K−1)th printing pass (for example, the first printing pass in the case of K=1) in the second storage device 51 (Step S28). On the other hand, in a case where the second controller 50 determines that the part or all of the joint area Rt does not overlap with the dark area Rd in the 2Kth printing pass (No in Step S26), the second controller 50 changes the numbers of nozzles of the first nozzles 121 and the second nozzles 221 to be used, i.e., decreases the number of nozzles to be used in the (2K−1)th printing pass (for example, the first printing pass in the case of K=1) (Step S27). After that, the second controller 50 returns to the process of Step S26 described above.

In a case where the second controller 50 determines that the dark area Rd is not present in the 2Kth printing pass (No in Step S25), the second controller 50 makes the setting (for example, turns ON a flag) so that the flushing process is executed after the 2Kth printing pass (for example, the second printing pass in the case of K=1) (Step S29). Then, the second controller 50 sets the numbers of nozzles of the first nozzles 121 and the second nozzles 221 to be used in the (2K−1)th printing pass (for example, the first printing pass in the case of K=1) to the maximum (Step S30). In this case, for example, 210 nozzles are disposed in the movement direction Ds in each of the first head 21 and the second head 22, the number of nozzles to be used is set to 210 with respect to each of the first nozzles 121 and the second nozzles 221.

Subsequently, the second controller 50 determines whether the process is completed up to the last printing pass (2). In a case where the second controller 50 determines that the process is not completed up to the last printing pass (No in Step S31), the second controller 50 sets the variable K to (K=K+1) (Step S32).

Then, the second controller 50 determines whether the flag of the flushing process is turned ON (Step S33). In a case where the second controller 50 determines that the flag of the flushing process is turned ON (Yes in step S33), the second controller 50 sets the numbers of the first nozzles 121 and the second nozzles 221 to be used in the (2K−1)th printing pass (for example, the third printing pass) to the maximum (Step S34). After that, the second controller 50 returns to the process of Step S26 to repeat this process and the following processes.

On the other hand, in a case where the second controller 50 determines that the flag of the flushing process is not turned ON (No in Step S33), the second controller 50 determines whether the part or all of the joint area Rt overlaps with the dark area Rd in the (2K−1)th printing pass (Step S35).

In a case where the second controller 50 determines that the part or all of the joint area Rt does not overlap with the dark area Rd in the (2K−1)th printing pass described above (No in Step S35), the second controller 50 decreases the numbers of nozzles of the first nozzles 121 and the second nozzles 221 to be used in the (2K−1)th printing pass (Step S36). After that, the second controller 50 returns to the process of Step S35 described above. On the other hand, in a case where the second controller 50 determines that the part or all of the joint area Rt overlaps with the dark area Rd in the (2K−1)th printing pass described above (Yes in Step S35), the second controller 50 stores the numbers of nozzles of the first nozzles 121 and the second nozzles 221 to be used in the (2K−1)th printing pass in the second storage device 51 (Step S37). The second controller 50 returns to the process of Step S31 described above to repeat this process and the following processes.

On the other hand, in a case where the second controller 50 determines that the process is completed up to the last printing pass (Yes in Step S31), the second controller 50 divides the printing pass based on the number of nozzles to be used (Step S38). In this case, the second controller 50 divides, based on the number of nozzles to be used, each of the printing passes with respect to the printing process to be executed. Further, the second controller 50 changes the conveyance amount of the printing medium W to be conveyed by the conveyor 40.

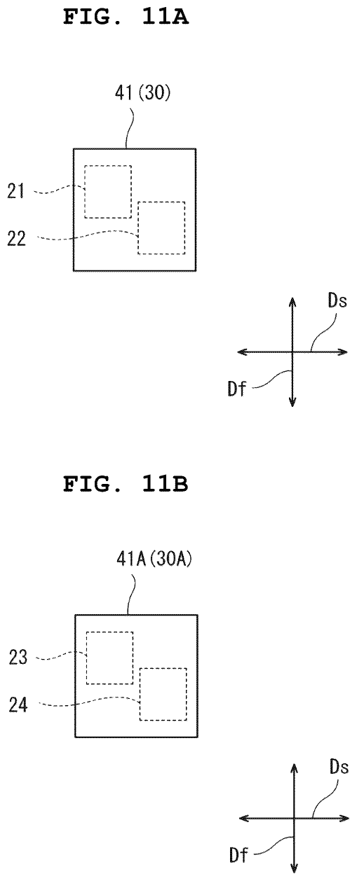

FIG. 11A and FIG. 11B illustrates a modification of the carriage depicted in FIG. 1. In FIG. 1, the carriage 41 is configured to support the first head 21, the second head 22, the third head 23, and the fourth head 24. However, the following configuration may be adopted. As depicted in FIG. 11A, the carriage 41 may support only the first head 21 and the second head 22. As depicted in FIG. 11B, a second moving device 30A, which includes a carriage 41A configured to support the third head 23 and the fourth head 24, may be included in the liquid droplet ejecting device 101A. Note that the configuration of the second moving device 30A is the same as the configuration of the moving device 30.

As described above, according to the liquid droplet ejecting device 101A, in a case where the part or all of the joint area Rt does not correspond to the dark area Rd, the number of the first nozzles 121 to be used relevant to the ejection and the number of the second nozzles 221 to be used relevant to the ejection are changed in the preceding printing pass, in the following printing pass, or both of the preceding printing pass and the following printing pass. Accordingly, the part or all of the joint area Rt can correspond to the dark area Rd, for example, in the following printing pass described above. That is, the ink droplets of the color ink, in which the total value of volume is the threshold value or more, can be ejected from the first nozzles 121 and the second nozzles 221, for example, in the following printing pass described above. Accordingly, the drying of the first nozzles 121 and the second nozzles 221 is reduced, and thus the ejection failure is less likely to occur.

Further, in the present embodiment, the second controller 50 generates the histogram HG of the obtained total value of volume. Accordingly, the first nozzles 121 and the second nozzles 221 in the joint area Rt can easily correspond to the dark area Rd as the area in which the total value of volume in the histogram HG is the threshold value or more.

Further, in the present embodiment, the second controller 50 may cause the third nozzles 321 and the fourth nozzles 421 to perform the ejection in the joint area Rt in the following printing pass, in preference to causing the first nozzles 121 and the second nozzles 221 to perform the ejection in the joint area Rt in the following printing pass. In this case, the ejection frequency can be raised with respect to the third nozzles 321 and the fourth nozzles 421 configured to eject the ink droplets of the special color ink of which ejection frequency is low as compared with the ejection frequency of the ink droplets of the color ink. Accordingly, the drying may be further reduced in the third nozzles 321 and the fourth nozzles 421.

Further, in the present embodiment, the second controller 50 may preferentially cause one of the nozzles, included in the first nozzles 121 and the second nozzles 221 and having fewer ejection histories than the other of the nozzles included in the first nozzles 121 and the second nozzles 221, to perform the ejection in the joint area Rt in the following printing pass, in preference to the other of the nozzles included in the first nozzles 121 and the second nozzles 221. Similarly, the second controller 50 may cause one of the nozzles, included in the third nozzles 321 and the fourth nozzles 421 and having fewer ejection histories than the other of the nozzles included in the third nozzles 221 and the fourth nozzles 421, to perform the ejection in the joint area Rt in the following printing pass, in preference to the other of the nozzles included in the third nozzles 221 and the fourth nozzles 421. Accordingly, the occurrence of the drying may be reduced in the nozzles in which the drying is more likely to occur on account of the fewer ejection history.

Further, in the present embodiment, the dark area Rd is the area which expands in the conveyance direction Df and the movement direction Ds. In this case, the first nozzles 121 and the second nozzles 221 in the joint area Rt in each printing pass can be caused to correspond to the dark area Rd more easily.

Further, in the present embodiment, the second controller 50 executes the process of determining whether the predetermined number of the following printing passes in which the part or all of the joint area Rt does not correspond to the dark area Rd are present. Then, in a case where the second controller 50 determines that the predetermined number or more of the following printing passes, in which the part or all of the joint area Rt does not correspond to the dark area Rd, are present, the second controller 50 executes the printing in the predetermined number of the following printing passes, and then the second controller 50 executes the flushing process. In this case, the flushing process is executed with respect to the first nozzles 121 and the second nozzles 221 in which the drying is more likely to occur on account of the presence of the predetermined number or more of the following printing passes in which the part or all of the joint area Rt does not correspond to the dark area Rd. Accordingly, the drying of the first nozzles 121 and the second nozzles 221 is reduced, and thus the ejection failure is less likely to occur.

Further, in the present embodiment, a carriage which supports the first head 21 and the second head 22 and a carriage which supports the third head 23 and the fourth head 24 may be configured to be independent from each other. In this case, the ejection control with respect to the ink droplets of the color ink and the ejection control with respect to the ink droplets of the special color ink can be performed easily.

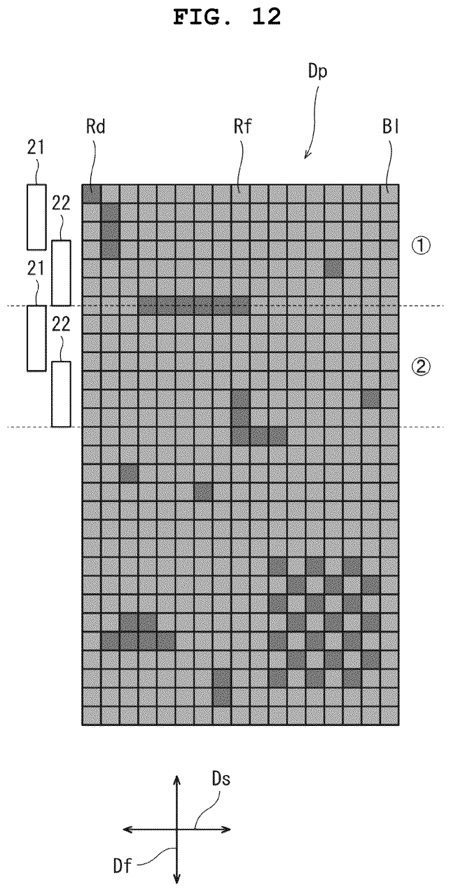

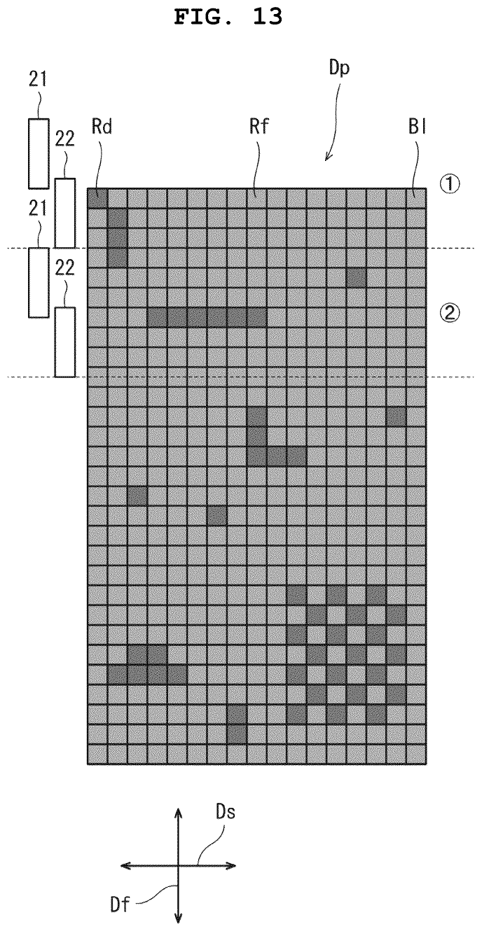

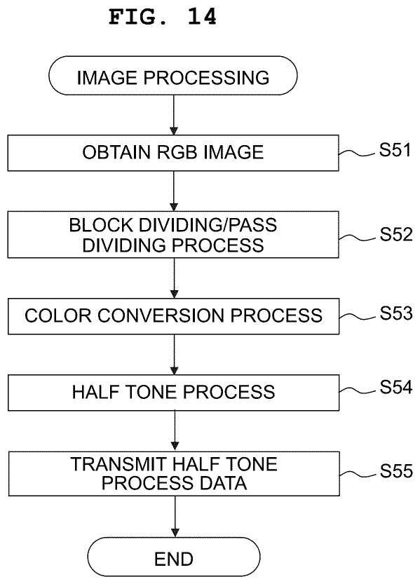

In a second embodiment, a method of obtaining the dark area Rd is different from the method of obtaining of the dark area Rd in the first embodiment. The method of obtaining the dark area Rd in the second embodiment will be described in detail below. FIG. 12 is a view illustrating examples of the dark area Rd and the light area Rf corresponding to each of printing passes of image data Dp. FIG. 13 is a view illustrating a printing pass in which a joint area Rt is made to correspond to dark areas Rd.

In the second embodiment, the first controller 61 obtains the image data Dp in the same manner as in the first embodiment. The image data Dp is exemplified, for example, by data in which each of RGB values has a value of 256 gradations. The first controller 61 executes a process of obtaining the weight value relevant to the color from the obtained image data Dp with respect to each of the pixels. The weight value is a value based on the RGB value of each pixel. This value represents the magnitude relevant to the reproducibility of a predetermined color of each pixel in a case where a predetermined color (for example, red color) of the respective colors of R (red), G (green), and B (blue) is deemed significant. For example, in a case where the predetermined color is the red color, it is assumed that the weight value is 10 when the RGB value is (255,0,0). On this assumption, in a case where the RGB value is, for example, (32,32,32), the weight value is 1.

Next, as depicted in FIG. 12, the first controller 61 divides the image data Dp into blocks B1 each of which is composed of a plurality of pixels. Each of the blocks B1 is composed, for example, of 60 pixels×60 pixels.

Then, the first controller 61 calculates the average value of the weight values of the plurality of pixels composing each of the blocks B1. The first controller 61 obtains the average value of the weight values for each of the blocks B1. Note that the average value of the weight values is calculated by dividing the total value of the weight values of the plurality of pixels composing each of the blocks B1 by the number of the pixels.

Subsequently, the first controller 61 obtains the dark area Rd as the area in which the average value of the weight values is a threshold value or more, with respect to each of the printing passes. Further, the first controller 61 obtains the light area Rf as the area in which the average value of the weight values is less than the threshold value, with respect to each of the printing passes. In this situation, in the image data Dp depicted in FIG. 12, an area depicted by the dark grey is the dark area Rd, and an area depicted by the light grey is the light area Rf. Further, in FIG. 12 and FIG. 13, the first printing pass and the second printing pass, which are examples of the printing passes of the first head 21 and the second head 22, are identified by numerals 1 and 2 placed in hollow circles.

Next, the first controller 61 determines whether a part or all of the joint area Rt described above corresponds to the dark area Rd in the following printing pass as the printing pass to be executed after the preceding printing pass as the predetermined printing pass. More specifically, in the present embodiment, the first controller 61 determines whether the part or all of the joint area Rt described above corresponds to the blocks B1 as the dark areas Rd of a predetermined number or more (for example, four) in the following printing pass. This situation will be described with reference to the example depicted in FIG. 12. That is, the first controller 61 determines that the part or all of the joint area Rt does not correspond to the blocks B1 as the dark areas Rd of the predetermined number or more in the second printing pass.

In view of the above, the first controller 61 executes the following process. That is, in order to cause the part or all of the joint area Rt to correspond to the blocks B1 as the dark areas Rd of the predetermined number or more in the second printing pass as the following printing pass, the first controller 61 changes the number of the first nozzles 121 to be used relevant to the ejection and the number of the second nozzles 221 to be used relevant to the ejection in the preceding printing pass. In this case, as depicted in FIG. 13, the first controller 61 decreases the number of the first nozzles 121 to be used relevant to the ejection and the number of the second nozzles 221 to be used relevant to the ejection in the first printing pass as the preceding printing pass so that the blocks B1 as the dark areas Rd of the predetermined number or more correspond to the part or all of the joint area Rt in the second printing pass as the following printing pass. In other words, the areas, which are formed by the first nozzles 121 and the second nozzles 221 in the first printing pass, are the light areas Rf, or no area which is to be formed by the first nozzles 121 and the second nozzles 221 is present. In combination with this, the first controller 61 changes the conveyance amount of the printing medium W by the conveyor 40 such that the part or all of the joint area Rt corresponds, in the second printing pass, to the blocks B1 as the dark areas Rd of the predetermined number or more, as described above. Note that in the same manner as the first embodiment, the first controller 61 may change the number of the first nozzles 121 to be used relevant to the ejection and the number of the second nozzles 221 to be used relevant to the ejection in the preceding printing pass, in the following printing pass, or in both of the preceding printing pass and the following printing pass. In accordance with the process as described above, in the example depicted in FIG. 13, the part or all of the joint area Rt corresponds to the six blocks B1 as the dark areas Rd in the second printing pass.

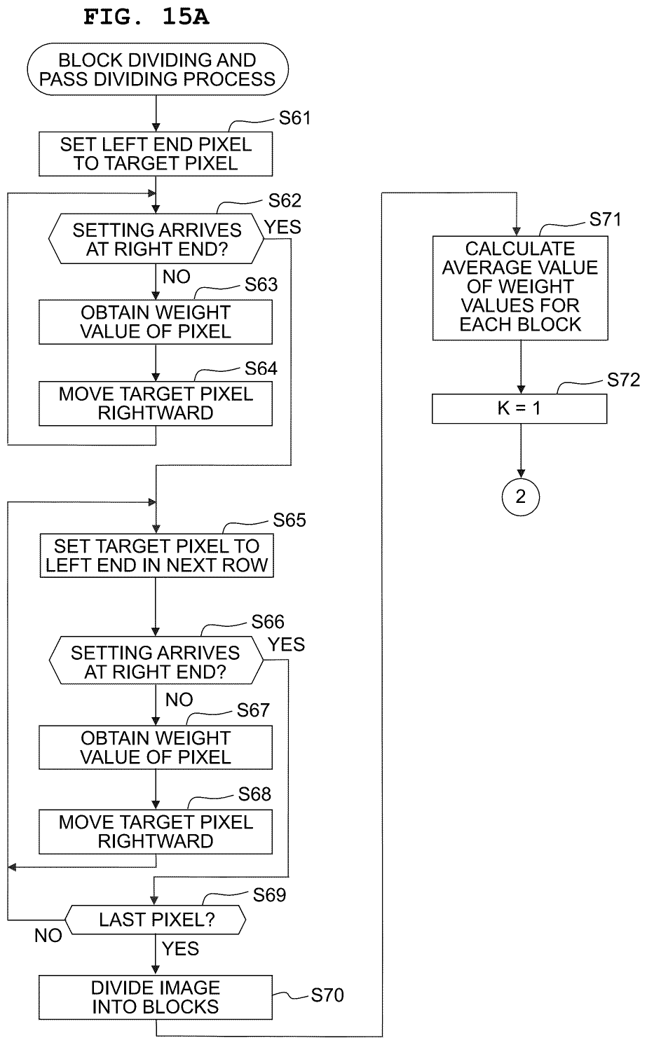

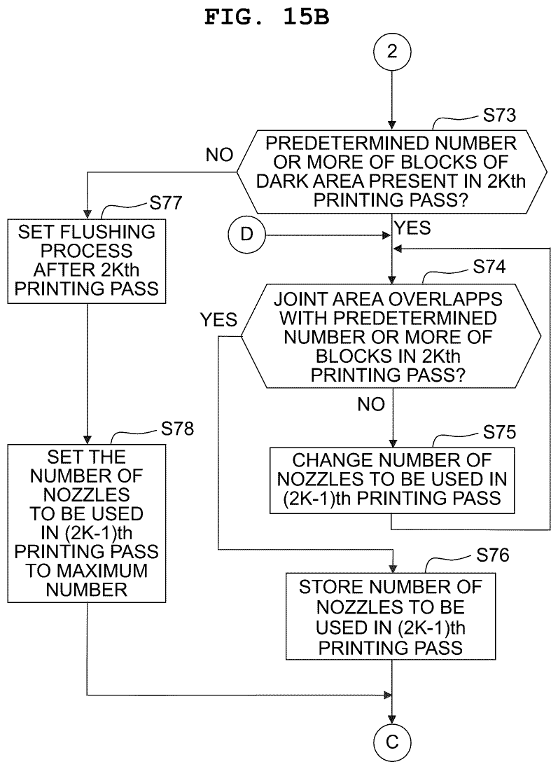

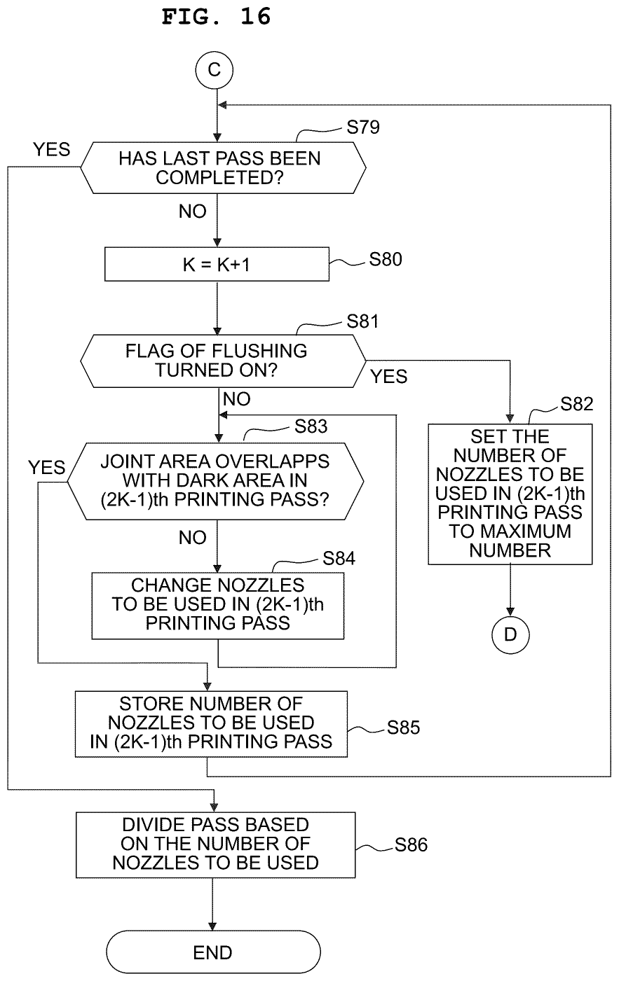

FIG. 14 is a flow chart illustrating the flow of a process performed in the printing apparatus 100 of the second embodiment. FIGS. 15A and 15B are a flow chart illustrating the flow of a block dividing and pass dividing process depicted in FIG. 14. FIG. 16 is a flow chart illustrating the flow of the block dividing and pass dividing process continued from FIG. 15B.

As depicted in FIG. 14, the first controller 61 firstly obtains image data composed of RGB values (Step S51). Subsequently, the first controller 61 executes the block dividing and pass dividing process as described later (Step S52). Next, the first controller 61 executes the color conversion process with respect to the image data after the block dividing and pass dividing process, and thus the first controller 61 obtains the image data represented by CMYK values as color coordinates in the CMYK space depending on the device (Step S53). Then, the first controller 61 applies a half tone process with respect to the image data after executing the color conversion process with respect to the image data, and thus the first controller 61 obtains the ejection data (Step S54). Next, the first controller 61 transmits the ejection data as the data after the half tone process to the second controller 50 of the output device 101 via the first communication interface 63 (Step S55).

In the block dividing and pass dividing process, as depicted in FIG. 15A, the first controller 61 firstly sets the left end pixel in the first row in the image data Dp to the target pixel (Step S61). Subsequently, the first controller 61 determines whether the setting of the target pixel arrives at the right end pixel in the first row (Step S62).

In a case where the first controller 61 determines that the setting of the target pixel does not arrive at the right end pixel in the first row (No in Step S62), the first controller 61 obtains the weight value corresponding to the pixel set as the target pixel (Step S63). Then, the first controller 61 changes and sets the target pixel from the left end pixel to the pixel located adjacent to the right of the left end pixel (Step S64), and then the first controller 61 returns to the process of Step S62 described above to repeat this process and the following processes.

On the other hand, in a case where the first controller 61 determines that the setting of the target pixel arrives at the right end pixel in the first row (Yes in Step S62), i.e., in a case where the obtainment of the weight values of all pixels in the first row is completed, the first controller 61 sets the left end pixel in the next row (for example, on the second row) in the image data Dp to be the target pixel (Step S65). After that, the first controller 61 determines whether the setting of the target pixel arrives at the right end pixel in the row (for example, the second row) relevant to the next row (Step S66).

In a case where the first controller 61 determines that the setting of the target pixel does not arrive at the right end pixel in the first row (No in Step S66), the first controller 61 obtains the weight value corresponding to the pixel described above set as the target pixel (Step S67). Then, the first controller 61 changes and sets the target pixel from the present pixel to the pixel located adjacent to the right of the present pixel (Step S68), and then the first controller 61 returns to the process of Step S65 described above to repeat this process and the following processes. On the other hand, in a case where the first controller 61 determines that the setting of the target pixel arrives at the right end pixel in the row (for example, the second row) relevant to the next row (Yes in Step S66), the first controller 61 determines whether the setting of the target pixel arrives at the last pixel (Step S69).

In a case where the first controller 61 determines that the setting of the target pixel does not arrive at the last pixel (No in Step S69), the first controller 61 returns to the process of Step S65 described above to repeat this process and the following processes. On the other hand, in a case where the first controller 61 determines that the setting of the target pixel arrives at the last pixel (Yes in Step S69), the first controller 61 divides the image data Dp into the blocks B1 composed of the plurality of pixels as exemplified in FIG. 12 (Step S70).

Subsequently, the first controller 61 calculates the average value of the weight values for each of the blocks B1 (Step S71). Then, the first controller 61 sets the variable K based on the ordinal number of the printing pass in relation to the first head 21 and the second head to be 1 (Step S72).

The first controller 61 determines whether a predetermined number or more of the blocks B1 as the dark areas Rd are present in the 2Kth printing pass as the following printing pass (for example, the second printing pass in the case of K=1) (Step S73). In a case where the first controller 61 determines that the predetermined number or more of the blocks B1 as the dark areas Rd are present in the 2Kth printing pass (Yes in Step S73), the first controller 61 determines whether a part or all of the joint area Rt overlaps with the predetermined number or more of the blocks B1 as the dark areas Rd in the 2Kth printing pass (Step S74).

In a case where the first controller 61 determines that the part or all of the joint area Rt overlaps with the predetermined number or more of the blocks B1 as the dark areas Rd in the 2Kth printing pass (Yes in Step S74), the first controller 61 stores the numbers of nozzles of the first nozzles 121 and the second nozzles 221 to be used in the (2K−1)th printing pass (for example, the first printing pass in the case of K=1) in the second storage device 51 (Step S76). On the other hand, in a case where the first controller 61 determines that the part or all of the joint area Rt does not overlap with the predetermined number or more of the blocks B1 as the dark areas Rd in the 2Kth printing pass (No in Step S74), the first controller 61 changes the numbers of nozzles of the first nozzles 121 and the second nozzles 221 to be used, i.e., decreases the number of nozzles to be used in the (2K−1)th printing pass (for example, the first printing pass in the case of K=1) (Step S75). After that, the first controller 61 returns to the process of Step S74 described above.

In a case where the first controller 61 determines that the predetermined number or more of the blocks B1 as the dark areas Rd are not present in the 2Kth printing pass (No in Step S73), the first controller 61 performs a setting (for example, turns ON a flag) so that the flushing process is executed after the 2Kth printing pass (for example, the second printing pass in the case of K=1) (Step S77). Then, the first controller 61 sets the numbers of nozzles of the first nozzles 121 and the second nozzles 221 to be used in the (2K−1)th printing pass (for example, the first printing pass in the case of K=1) to the maximum (Step S78).

Subsequently, the first controller 61 determines whether the process is completed until arrival at the last printing pass (Step S79). In a case where the first controller 61 determines that the process is not completed up to the last printing pass (No in Step S79), the first controller 61 sets the variable K to (K+1) (Step S80).

Then, the first controller 61 determines whether the flag of the flushing process is turned ON (Step S81). In a case where the first controller 61 determines that the flag of the flushing process is turned ON (Yes in step S81), the first controller 61 sets the numbers of nozzles of the first nozzles 121 and the second nozzles 221 to be used in the (2K−1) printing pass (for example, the third printing pass) to the maximum (Step S82). After that, the first controller 61 returns to the process of Step S74 to repeat this process and the following processes.

On the other hand, in a case where the first controller 61 determines that the flag of the flushing process is not turned ON (No in Step S81), the first controller 61 determines whether the part or all of the joint area Rt overlaps with the predetermined number or more of the blocks B1 as the dark areas Rd in the (2K−1)th printing pass (Step S83).

In a case where the first controller 61 determines that the part or all of the joint area Rt does not overlap with the predetermined number or more of the blocks B1 as the dark areas Rd in the (2K−1)th printing pass described above (No in Step S83), the first controller 61 decreases the number of nozzles of the first nozzles 121 and the second nozzles 221 to be used in the (2K−1)th printing pass (Step S84). After that, the first controller 61 returns to the process of Step S83 described above. On the other hand, in a case where the first controller 61 determines that the part or all of the joint area Rt overlaps with the predetermined number or more of the blocks B1 as the dark areas Rd in the (2K−1)th printing pass described above (Yes in Step S83), the first controller 61 stores the number of nozzles of the first nozzles 121 and the second nozzles 221 to be used in the (2K−1)th printing pass in the second storage device 51 (Step S85). The first controller 61 returns to the process of Step S79 described above to repeat this process and the following processes.

On the other hand, in a case where the first controller 61 determines that the process is completed up to arrival at the last printing pass (Yes in Step S79), the first controller 61 divides the printing pass based on the number of nozzles to be used (Step S86). In this case, the first controller 61 divides each of the printing passes with respect to the printing process to be executed based on the number of nozzles to be used. Further, the first controller 61 changes the conveyance amount of the printing medium W to be conveyed by the conveyor 40.

As described above, according to the second embodiment, in a case where the part or all of the joint area Rt does not correspond to the predetermined number or more of the blocks B1 as the dark areas Rd, the number of the first nozzles 121 to be used relevant to the ejection and the number of the second nozzles 221 to be used relevant to the ejection are changed in the preceding printing pass, in the following printing pass, or in both of the preceding printing pass and the following printing pass. Accordingly, the part or all of the joint area Rt can be caused to correspond to the predetermined number or more of the blocks B1 as the dark areas Rd, for example, in the following printing pass described above. That is, the ink droplets of the color ink, which correspond to the predetermined number or more of the dark areas Rd (the predetermined number or more of the blocks B1) as the areas having the average value of the weight values of the threshold value or more, can be ejected from the first nozzles 121 and the second nozzles 221, for example, in the following printing pass described above. Accordingly, the drying of the first nozzles 121 and the second nozzles 221 is reduced, and thus the ejection failure is less likely to occur.

Note that the present disclosure is not limited to the embodiments described above. Modifications can be adopted within a range without deviating from the gist or characteristics of the present disclosure. The modifications are, for example, as follows.

In the second embodiment described above, the block dividing and pass dividing process is executed before the color conversion process. The present disclosure, however, is not limited to this. The block dividing and pass dividing process may be executed after the color conversion process.

Further, in the embodiments described above, the carriage includes the first head 21 and the second head 22 configured to eject the ink droplets of the color ink and the third head 23 and the fourth head 24 configured to eject the ink droplets of the special color ink. The present disclosure, however, is not limited to this. A head configured to eject ink droplets of a white ink or a head configured to eject ink droplets of a clear ink may be included.

Further, in the embodiment described above, the image processing device 102 and the output device 101 are configured individually and independently, and the concept including the image processing device 102 and the output device 101 is regarded as the printing apparatus (or the printer system) 100. The present disclosure, however, is not limited to this. A processing part capable of executing the same process as the process performed by the image processing device 102 and a processing part capable of executing the same process as the process performed by the output device 101 may be included in a printing apparatus constructed, for example, of one printer.

Further, in the embodiments described above, each of the heads 20 is based on the serial head system. However, each of the heads 20 may be based on the line head system.

What is claimed is:

1. A liquid droplet ejecting apparatus, comprising:
a first head having a plurality of first nozzles, first liquid droplets being ejected from the plurality of first nozzles based on image data;
a second head having a plurality of second nozzles, second liquid droplets of a same color as a color of the first liquid droplets being ejected from the plurality of second nozzles, based on the image data;
a conveyor, a printing medium being conveyed by the conveyor in a conveyance direction with respect to the first head and the second head;
a first moving device, the first head and the second head being moved by the first moving device in a movement direction crossing the conveyance direction; and
a controller,
wherein the first head and the second head are disposed such that positions of first nozzles as a part of the plurality of first nozzles and positions of second nozzles as a part of the plurality of second nozzles overlap with one another in the conveyance direction in a predetermined joint area, and
the controller is configured to execute:
a process of obtaining a dark area from ejection data as data after execution of a half tone process with respect to the image data, the dark area being an area with a total value of volume being a threshold value or more, the total value of volume being a total value of a cumulative volume of the first liquid droplets ejected from a row of the first nozzles aligned in the movement direction and a cumulative volume of the second liquid droplets ejected from a row of the second nozzles aligned in the movement direction;
a process of determining whether a part or all of the joint area corresponds to the dark area in a following printing pass to be executed after a preceding printing pass as a predetermined printing pass; and
a process of changing a number of the first nozzles to be used relevant to ejection and a number of the second nozzles to be used relevant to the ejection in the preceding printing pass, in the following printing pass, or in both of the preceding printing pass and the following printing pass such that the part or all of the joint area corresponds to the dark area in the following printing pass, in a case where the part or all of the joint area does not correspond to the dark area.

2. The liquid droplet ejecting apparatus according to claim 1, wherein the controller is configured to generate a histogram of the total value of volume.

3. The liquid droplet ejecting apparatus according to claim 1, further comprising:
a third head having a plurality of third nozzles, third liquid droplets being ejected from the plurality of third nozzles based on the image data; and
a fourth head having a plurality of fourth nozzles, fourth liquid droplets having a same color as a color of the third liquid droplets being ejected from the plurality of fourth nozzles, based on the image data,
wherein the conveyor is configured to convey the printing medium in the conveyance direction with respect to the third head and the fourth head,
the first moving device is configured to move the third head and the fourth head in the movement direction,
the controller is configured to cause the first head to eject color ink droplets as the first liquid droplets from the plurality of first nozzles and cause the second head to eject the color ink droplets as the second liquid droplets from the plurality of second nozzles,
the controller is configured to cause the third head to eject special color ink droplets as the third liquid droplets from the plurality of third nozzles and cause the fourth head to eject the special color ink droplets as the fourth liquid droplets from the plurality of fourth nozzles,
the third head and the fourth head are disposed such that positions of third nozzles as a part of the plurality of third nozzles and positions of fourth nozzles as a part of the plurality of fourth nozzles overlap with one another in the conveyance direction in another joint area, and
in the following printing pass, the controller is configured to cause the third head and the fourth head to eject the special color ink droplets from the third nozzles and the fourth nozzles in the another joint area in preference to causing the first head and the second head to eject the color ink droplets form the first nozzles and the second nozzles in the joint area.

4. The liquid droplet ejecting apparatus according to claim 1, wherein in the following printing pass, the controller is configured to give priority to ejecting from nozzles with fewer ejections among the first nozzles and the second nozzles included in the joint area.

5. The liquid droplet ejecting apparatus according to claim 1, wherein the dark area expands in the conveyance direction and the movement direction.

6. The liquid droplet ejecting apparatus according to claim 1, further comprising a receiving part, the first liquid droplets ejected from the plurality of first nozzles and the second liquid droplets ejected from the plurality of second nozzles being received by the receiving part,
wherein the controller is configured to further execute a process of determining whether a number of the following printing passes with the joint area not corresponding to the dark area is a predetermined number or more, after obtaining the dark area, and
in a case where the number of the following printing passes with the joint area not corresponding to the dark area is the predetermined number or more, the controller is configured to execute a flushing process of causing the first head to discharge the first liquid droplets from the plurality of first nozzles to the receiving part and causing the second head to discharge the second liquid droplets from the plurality of second nozzles to the receiving part after executing printing in the following printing passes of the predetermined number.

7. The liquid droplet ejecting apparatus according to claim 1, further comprising:
a third head having a plurality of third nozzles, third liquid droplets being ejected from the plurality of third nozzles based on the image data;
a fourth head having a plurality of fourth nozzles, fourth liquid droplets having a same color as a color of the third liquid droplets being ejected from the plurality of fourth nozzles, based on the image data; and
a second moving device, the third head and the fourth head being moved by the second moving device in the movement direction,
wherein the conveyor is configured to convey the printing medium in the conveyance direction with respect to the third head and the fourth head,
the controller is configured to cause the first head to eject color ink droplets as the first liquid droplets from the plurality of first nozzles and cause the second head to eject the color ink droplets as the second liquid droplets from the plurality of second nozzles,
the controller is configured to cause the third head to eject special color ink droplets as the third liquid droplets from the plurality of third nozzles and cause the fourth head to eject the special color ink droplets as the fourth liquid droplets from the plurality of fourth nozzles,
the third head and the fourth head are disposed such that positions of third nozzles as a part of the plurality of third nozzles and positions of fourth nozzles as a part of the plurality of fourth nozzles overlap with one another in the conveyance direction in another joint area, and
in the following printing pass, the controller is configured to cause the third head and the fourth head to eject the special color ink droplets from the third nozzles and the fourth nozzles in the another joint area in preference to causing the first head and the second head to eject the color ink droplets form the first nozzles and the second nozzles in the joint area.

8. A liquid droplet ejecting apparatus comprising:
a first head having a plurality of first nozzles, first liquid droplets being ejected from the plurality of first nozzles based on image data;
a second head having a plurality of second nozzles, second liquid droplets having a same color as a color of the first liquid droplets being ejected from the plurality of second nozzles, based on the image data;
a conveyor, a printing medium being conveyed by the conveyor in a conveyance direction with respect to the first head and the second head;
a moving device, the first head and the second head being moved in a movement direction crossing the conveyance direction; and
a controller,
wherein the first head and the second head are disposed such that positions of first nozzles as a part of the plurality of first nozzles and positions of second nozzles as a part of the plurality of second nozzles overlap with one another in the conveyance direction in a predetermined joint area, and
the controller is configured to execute:
a process of obtaining a weight value relevant to a color from the image data with respect to each of pixels;
a process of dividing the image data into blocks each composed of a plurality of pixels;
a process of calculating, with respect to each of the blocks, an average value of weight values of pixels, included in the plurality of pixels and composing each of the blocks;
a process of obtaining a dark area with the average value of the weight values being a threshold value or more, for each printing pass;
a process of determining whether a part or all of the joint area corresponds to the dark area in a following printing pass to be executed after a preceding printing pass as a predetermined printing pass; and
a process of changing a number of the first nozzles to be used relevant to ejection and a number of the second nozzles to be used relevant to the ejection in the preceding printing pass, in the following printing pass, or in both of the preceding printing pass and the following printing pass such that the part or all of the joint area corresponds to the dark area in the following printing pass, in a case where the part or all of the joint area does not correspond to the dark area.

9. The liquid droplet ejecting apparatus according to claim 8, further comprising a receiving part, the first liquid droplets ejected from the plurality of first nozzles and the second liquid droplets ejected from the plurality of second nozzles being received by the receiving part,
wherein the controller is configured to further execute a process of determining whether a number of the following printing passes with the joint area not corresponding to the dark area is a predetermined number or more, after obtaining the dark area, and
in a case where the number of the following printing passes with the joint area not corresponding to the dark area is the predetermined number or more, the controller is configured to execute a flushing process of causing the first head to discharge the first liquid droplets from the plurality of first nozzles to the receiving part and causing the second head to discharge the second liquid droplets from the plurality of second nozzles to the receiving part after executing printing in the following printing passes of the predetermined number.

10. A liquid droplet ejecting method using a liquid droplet ejecting apparatus, the liquid droplet ejecting apparatus including: a first head having a plurality of first nozzles, first liquid droplets being ejected from the plurality of first nozzles based on image data, a second head having a plurality of second nozzles, second liquid droplets having a same color as a color of the first liquid droplets being ejected from the plurality of second nozzles, based on the image data, and a controller, the first head and the second head being disposed such that positions of first nozzles as a part of the plurality of first nozzles and positions of second nozzles as a part of the plurality of second nozzles overlap with one another in a conveyance direction of a printing medium in a predetermined joint area,
the liquid droplet ejecting method comprising:
obtaining a dark area from ejection data as data after execution of a half tone process with respect to the image data, the dark area being an area with a total value of volume being a threshold value or more, the total value of volume being a total value of a cumulative volume of the first liquid droplets ejected from a row of the first nozzles aligned in a movement direction crossing the conveyance direction and a cumulative volume of the second liquid droplets ejected from a row of the second nozzles aligned in the movement direction;
determining whether a part or all of the joint area corresponds to the dark area in a following printing pass to be executed after a preceding printing pass as a predetermined printing pass; and
changing a number of the first nozzles to be used relevant to ejection and a number of the second nozzles to be used relevant to the ejection in the preceding printing pass, in the following printing pass, or in both of the preceding printing pass and the following printing pass such that the part or all of the joint area corresponds to the dark area in the following printing pass, in a case where the part or all of the joint area does not correspond to the dark area.

11. A non-transitory medium storing a program for a liquid droplet ejecting apparatus, the liquid droplet ejecting apparatus including a first head having a plurality of first nozzles, first liquid droplets being ejected from the plurality of first nozzles based on image data, a second head having a plurality of second nozzles, second liquid droplets having a same color as a color of the first liquid droplets being ejected from the plurality of second nozzles based on the image data, and a controller, the first head and the second head being disposed such that positions of first nozzles as a part of the plurality of first nozzles and positions of second nozzles as a part of the plurality of second nozzles overlap with one another in a conveyance direction of a printing medium in a predetermined joint area,
the program for the liquid droplet ejecting apparatus causing the controller to execute:
a process of obtaining a dark area from ejection data as data after execution of a half tone process with respect to the image data, the dark area being an area with a total value of volume being a threshold value or more, the total value of volume being a total value of a cumulative volume of the first liquid droplets ejected from a row of the first nozzles aligned in a movement direction crossing the conveyance direction and a cumulative volume of the second liquid droplets ejected from a row of the second nozzles aligned in the movement direction;
a process of determining whether a part or all of the joint area corresponds to the dark area in a following printing pass to be executed after a preceding printing pass as a predetermined printing pass; and
a process of changing a number of the first nozzles to be used relevant to ejection and a number of the second nozzles to be used relevant to the ejection in the preceding printing pass, in the following printing pass, or in both of the preceding printing pass and the following printing pass such that the part or all of the joint area corresponds to the dark area in the following printing pass, in a case where the part or all of the joint area does not correspond to the dark area.
